(19) United States
(12) Patent Application Publication
(10) Pub. No.: US 2024/0412283 A1
(43) Pub. Date: Dec. 12, 2024

(54) ANALYSIS OF ENERGY RESERVES

(71) Applicant: Wells Fargo Bank, N.A., San Francisco, CA (US)

(72) Inventors: John Melton, Tomball, TX (US); Greg Daniel Cooper, Charlotte, NC (US); Zeeshan Niazi, Tracy, CA (US); Vasudha Alladi, Fremont, CA (US); John L. Schweer, III, San Francisco, CA (US); Carla E. Truluck, Charlotte, NC (US); Yi Wang, San Ramon, CA (US); Mrinal K. Samanta, Charlotte, NC (US); Daniel A. Ramos, Coppell, TX (US); Miguel Martinez, San Francisco, CA (US)

(21) Appl. No.: 17/118,363

(22) Filed: Dec. 10, 2020

(51) Int. Cl. G06Q 40/02; G06F 17/18; G06Q 40/06; G06Q 50/02; G06Q 50/06

(52) U.S. Cl. CPC G06Q 40/03; G06F 17/18; G06Q 40/06; G06Q 50/02; G06Q 50/06

(57) ABSTRACT

This disclosure describes techniques applied in an engineering analysis of energy asset information. In one example, this disclosure describes a method that includes collecting energy asset data maintained by a borrower; receiving information about a first set of parameters for use in evaluating the energy asset data maintained by the borrower; generating, based on the energy asset data and the first set of parameters, cash flow data for the borrower; calculating, based on the cash flow data, borrowing base data for the borrower; receiving information about a second set of parameters; generating, based on the cash flow data and the second set of parameters, adjusted cash flow data; and calculating, based on the adjusted cash flow data, updated borrowing base data for the borrower.

### TECHNICAL FIELD

This disclosure relates to analysis of data, and more specifically, to an engineering analysis of reserves in the energy industry.

### BACKGROUND

The oil and gas industry is vital to the proper function of a modern economy, providing fuels needed for transportation and heating, as well as raw materials used in construction and manufacturing. Exploration companies in the industry find, develop, and produce oil, natural gas, and natural gas liquids. Such companies manage their development and production costs to generate profit margins, which are often highly dependent upon market prices of commodities. When commodity prices are volatile, the value of oil and gas reserves is affected, and as a result, cash flow volatility may increase for companies that find, develop, and produce energy reserves.

### SUMMARY

This disclosure describes techniques applied in an engineering analysis of energy asset information. Such an analysis may be performed for the purpose of establishing and certifying borrowing thresholds for lenders that serve businesses in the petroleum and/or oil and gas industry. In some examples, analysis of energy assets involves importing cash flow projections received from current or prospective borrowers. Such entities (“borrowing entities”) are often businesses engaged in developing and producing energy reserves, such as oil, gas, and natural gas liquids. A lender may determine an amount of credit to extend to a borrowing entity based on a borrowing threshold. A borrowing threshold (or “borrowing base”) is a value or set of values determined by analyzing cash flow projections for business operations relating to the exploration, development, and/or production of energy reserves.

In accordance with techniques described herein, a computing system may determine borrowing thresholds and other information for a borrowing entity by processing the cash flow projections associated with that borrowing entity using complex algorithms to create periodic (e.g., annual) production output schedules. In some implementations, the computing system ingests business operation data from multiple potential borrowing entities, and transforms the data into a set of cash flows having a relatively uniform, readable, and coherent form. The computing system may make appropriate adjustments to the cash flows in light of any hedging strategies that might be employed by the borrowing entity to offset risk in the expected production output of energy reserves. To make adjustments to account for such hedging strategies, the computing system may process the business operation data for each potential borrowing entity to categorize, transform, and interpret such data in a way that properly accounts for the hedging strategies employed by that borrowing entity. In some examples, and as described herein, the computing system may enable effective consideration of hedging strategies based on long-range pricing forecasts, which may be ten years or longer. Hedging strategy assessments and valuations may be more accurate if based on long-range pricing forecasts.

Once business operation data from a given borrowing entity is properly interpreted, the computing system may use the cash flow information to formulate a range of present values (ranging from conservative to more aggressive) that apply to the entity's assets and holdings. The computing system may also generate a range of borrowing base values corresponding to the range of present values.

In some examples, the computing system may later calculate an updated range of present values and/or borrowing base values based on new assumptions, price decks, and other information. To do so, the computing system may make adjustments to data (e.g., cash flow data) generated in a prior analysis, and without performing a new, full evaluation of updated energy asset data. The computing system may then use the adjusted data as the basis for determining updated present values and/or borrowing base values reflecting the new assumptions, price decks, and other information. Using such a technique, accurate or at least sufficiently accurate updated values may be determined expeditiously and efficiently, without requiring a full analysis or re-analysis of a borrowing entity's energy asset data.

Such techniques may provide certain technical advantages. For instance, in examples where calculations are performed based on adjustments made to cash flow data generated in a prior analysis, significant computing cycles may be saved, since such calculations may often be performed much more efficiently. In addition, by performing calculations using such adjustments, significant additional processing may be avoided, including processing that might require skilled human intervention. Performing calculations based on a prior analysis can be performed with many fewer calculations and with much less human intervention, and as a result, in a dramatically shorter period of time.

In some examples, this disclosure describes operations performed by a computing system in accordance with one or more aspects of this disclosure. In one specific example, this disclosure describes a method comprising collecting, by a computing system, energy asset data maintained by a borrower; receiving, by the computing system, information about a first set of parameters for evaluating the energy asset data maintained by the borrower; generating, by the computing system and based on the energy asset data and the first set of parameters, cash flow data for the borrower; calculating, by the computing system and based on the cash flow data, borrowing base data for the borrower; receiving, by the computing system, information about a second set of parameters; generating, by the computing system and based on the cash flow data and the second set of parameters, adjusted cash flow data; and calculating, by the computing system and based on the adjusted cash flow data, updated borrowing base data for the borrower.

In another example, this disclosure describes a system comprising a storage system and processing circuitry having access to the storage system, wherein the processing circuitry is configured to carry out operations described herein. In yet another example, this disclosure describes a computer-readable storage medium comprising instructions that, when executed, configure processing circuitry of a computing system to carry out operations described herein.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1A is a conceptual diagram illustrating an example system for analysis of property interests, reserves, and cash flows for a plurality of entities in the petroleum energy industry, in accordance with one or more aspects of the present disclosure.

FIG. 1B is a graph illustrating a linear regression analysis that may be performed to estimate the value of a cash flow item using cash flow data associated with four different price decks.

FIG. 2 is a block diagram illustrating an example system for analysis of property interests, reserves, and cash flows for a plurality of entities in the petroleum energy industry, in accordance with one or more aspects of the present disclosure.

FIG. 3A through FIG. 3D are conceptual diagrams illustrating example user interfaces presented by a user interface device in accordance with one or more aspects of the present disclosure.

FIG. 4A through FIG. 4K are conceptual diagrams illustrating example user interfaces that may be presented by a user interface device in accordance with one or more aspects of the present disclosure.

FIG. 5A through FIG. 5F are flow diagrams illustrating operations performed by an example computing system in accordance with one or more aspects of the present disclosure.

FIG. 6 is a flow diagram illustrating operations performed by an example lender computing system in accordance with one or more aspects of the present disclosure.

### DETAILED DESCRIPTION

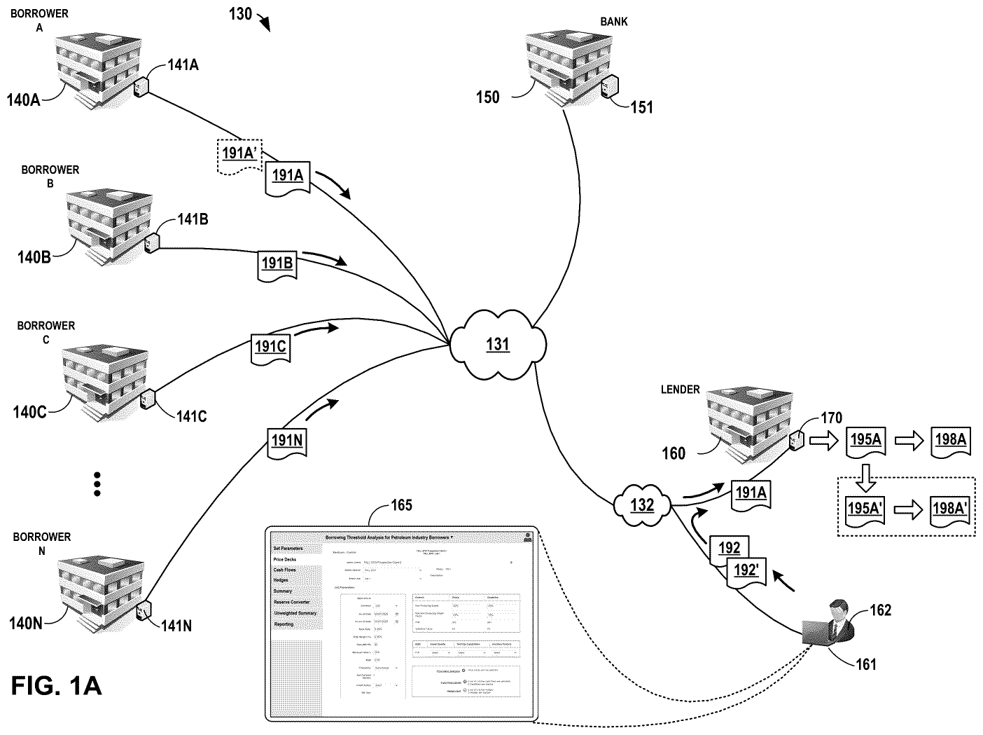

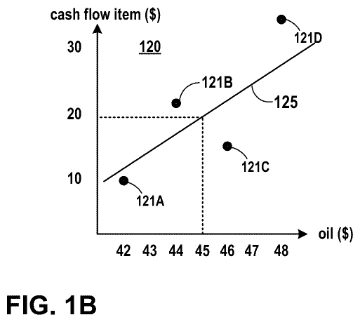

FIG. 1A is a conceptual diagram illustrating an example system for analysis of property interests, reserves, and cash flows for a plurality of entities in the petroleum energy industry, in accordance with one or more aspects of the present disclosure. FIG. 1A includes representations of a number of entities, each a participant in the energy industry, and in particular, in the petroleum and/or oil and gas industry. In the example illustrated in FIG. 1A, each of entities 140A, 140B, 140C, through entity 140N (collectively “entities 140,” representing any number of entities) may correspond to a business engaged in exploration and production of energy reserves. Typically, such entities find, develop, and produce oil, natural gas, and natural gas liquids (NGL). Often, the business model for each of entities 140 involves managing development and production costs to emphasize production volume to generate profit margins for the sale of developed or mined assets. The mined assets are generally each traded in public commodities markets, and the profit margins for the commodities are sensitive to the market prices on such markets. This sensitivity can cause volatility in the cash flow for entities 140 and in the value of the oil and gas reserves held by each of entities 140. Although this disclosure primarily describes techniques for establishing and certifying borrowing thresholds for extending credit in the context of the oil and gas industry, techniques described herein may also be applicable to other industries and in other contexts, and this disclosure shall be interpreted to encompass such other industries and contexts.

To assist one or more of entities 140 in managing their cash flow and for other reasons, bank 150 and/or lender 160 may provide credit to one or more of entities 140. Bank 150 is a financial institution or bank. Lender 160 is a lender in the business of providing credit to entities 140. In the example illustrated in FIG. 1A, bank 150 is shown separate from lender 160. In other examples, however, bank 150 and lender 160 may be the same entity, or lender 160 and bank 150 may have a parent-subsidiary relationship or other affiliation. In some examples, lender 160 may be an entity separate from bank 150 that, using banking services provided by bank 150, extends credit to one or more of entities 140.

In general, in the example of FIG. 1A, lender 160 helps finance exploration and production activities and other expenses undertaken by one or more of entities 140. Repayment of financing provided to one or more of entities 140 by lender 160 may be through revenues and cash flows generated by respective entities 140, generally as a result of the successful acquisition, development, completion, and production of oil and gas reserves, and secondarily on the liquidation of such reserves securing the debt. Often, entities 140 obtain financing through a reserve-based loan from lender 160, which may be a revolving facility secured by lower-risk “proved” reserves, which are reserves that are virtually certain to produce economically valuable oil and/or gas resources. Such a loan may be governed by a borrowing base determined by lender 160 through an engineering-based valuation of reserves owned or controlled by respective entities 140.

The borrowing base for loans to entities 140 may considered to be the lending commitment established by engineering-based valuation of the borrower's proved reserves, and may be subject to certain limitations and adjustments. The borrowing base may be determined, at least in part, by analyzing previous production reports and independent engineering evaluations, and may govern the maximum amount of credit available under the reserve-based loan at any one time. Credit risk to lender 160 in financing entities 140 often arises from the ability or inability of each entity 140 to repay debt with operating cash flow generated from the production and sale of oil and natural gas. The repayment capacity of each entity 140 thus significantly depends on the entity's ability to economically and successfully acquire, develop, and produce oil and gas reserves on an ongoing basis. Accordingly, lender 160 has an interest in ensuring that the commodity prices, risk adjustment factors, and cash flow discount rate used to determine reserve values and the borrowing base is fully supported and accurate, and as a result, lender 160 may often use multiple sets of assumptions (e.g., multiple sets of forecasted prices) when underwriting loans to entities 140.

Therefore, in accordance with one or more aspects of the present disclosure, lender computing system 170 may collect data pertaining to energy assets from one or more of entities 140. For instance, in some examples, one or more of entities 140 may seek to establish a borrower-lender relationship with bank 150 and/or lender 160. Pursuant to establishing such a relationship, each of entities 140 may provide lender 160 with access to information (e.g., energy asset data 191) about its property interests, energy reserves, and cash flow.

In the example of FIG. 1A, each of entities 140 may own, control, or otherwise have access to one or more entity computing systems 141. As illustrated, for example, entity computing system 141A may be controlled by entity 140A, entity computing system 141B may be controlled by entity 140B, and entity computing system 141C may be controlled by entity 140C. In general, entity computing system 141N may be controlled by entity 140N.

Each of bank 150 and lender 160 may also own, control, or otherwise have access to various computing resources. For example, bank 150 may own, control, or otherwise have access to banking system 151. Lender 160 may own, control, or otherwise have access to lender computing system 170. Lender 160 may also own or control administrator device 161, which is shown operated by administrator 162 (e.g., an employee or agent of lender 160). Lender computing system 170 and administrator device 161 may communicate over network 132, which may serve as a private or local network that has access to network 131. In other examples, network 132 may be part of network 131. Although shown separately in FIG. 1A, some or all aspects of administrator device 161 and 170 may, in other examples, be integrated into the same system.

In the example of FIG. 1A, each of administrator device 161, lender computing system 170, banking system 151, and entity computing systems 141 are capable of communicating over network 131. Network 131 may be the internet, or may include or represent any public or private communications network or other network. Network 132 may be part of network 131, or may be a private or local network that has access to network 131.

In one example that can be described in the context of FIG. 1A, entity 140A may seek to establish a lending relationship with lender 160. Entity 140A may therefore provide energy asset data 191A to lender 160 by causing entity computing system 141A to output a signal over network 131 and network 132. Lender computing system 170 detects a signal and determines that the signal provides or enables access to energy asset data 191A from entity computing system 141A. Lender computing system 170 accesses the data and stores energy asset data 191A for later use and/or analysis. Similarly, to the extent that one or more other entities 140 seek to establish a lending relationship with lender 160, one or more of entity computing systems 141 (e.g., entity computing system 141B and entity computing system 141C, associated with entities 140A and 141B, respectively) may also communicate information about their property interests, reserves, and financial information (i.e., energy asset data 191B and energy asset data 191C, respectively) over network 131 to lender computing system 170. Lender computing system 170 may detect such signals (e.g., over networks 131 and 132) and also store corresponding energy asset data 191B and 191C for each of entities 140B and 140C.

Lender computing system 170 may process energy asset data 191 from one or more entities 140 in order to standardize or normalize the information included within energy asset data 191. For instance, in some examples, each of energy asset data 191A, 191B, and 191C may include information sufficient to determine expected cash flows resulting from energy reserves held by each respective entity 140, but such information may be maintained by each of entities 140 in significantly different forms. As a result, generating cash flow data from energy asset data 191 from each different entity 140 typically involves significantly different processes, interpretation steps, accounting adjustments, and normalization steps. Accordingly, generating a standardized, normalized, readable, and/or uniform set of data from which a cash flow can be calculated can be tedious, complicated, and time-consuming. In some examples, a number of manual, human-performed adjustments might be required in order for lender computing system 170 to process such data effectively. Such adjustments may require as many as tens of hours or more of skilled human intervention for each of entities 140. Such adjustments may also involve processing and/or transforming each set of energy asset data 191 into a form suitable for use by commercially-available software designed for generating energy reserves economics cash flows, forecasts, and management information. Such commercially-available software may include “PHDwin” available from TRC Consultants (see www.phdwin.com), “ARIES® Petroleum Economics Software” available from Landmark Solutions (see www.landmark.solutions), and/or “Val Nav” available from Aucerna (see www.aucerna.com).

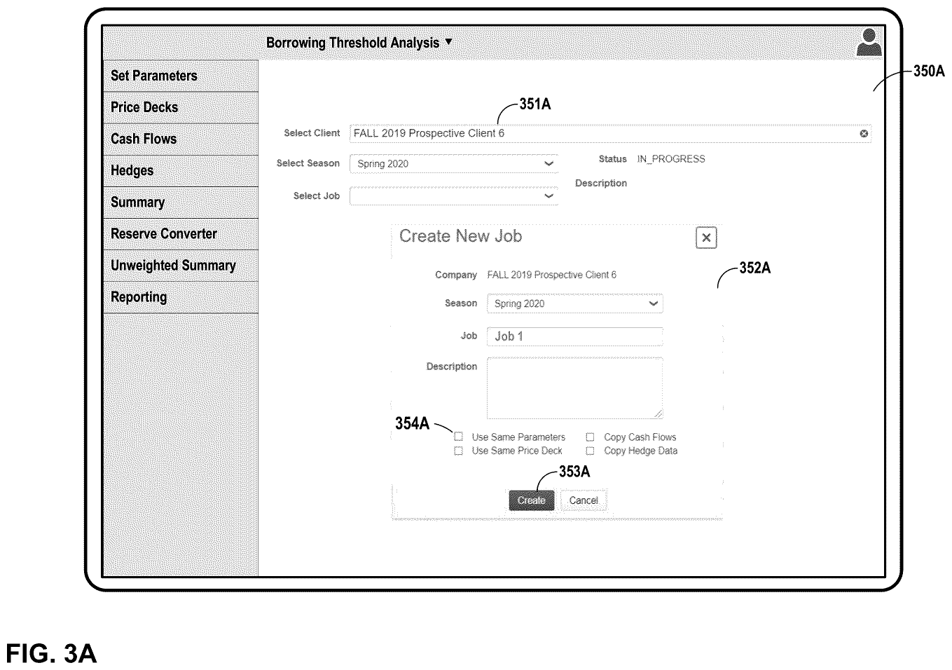

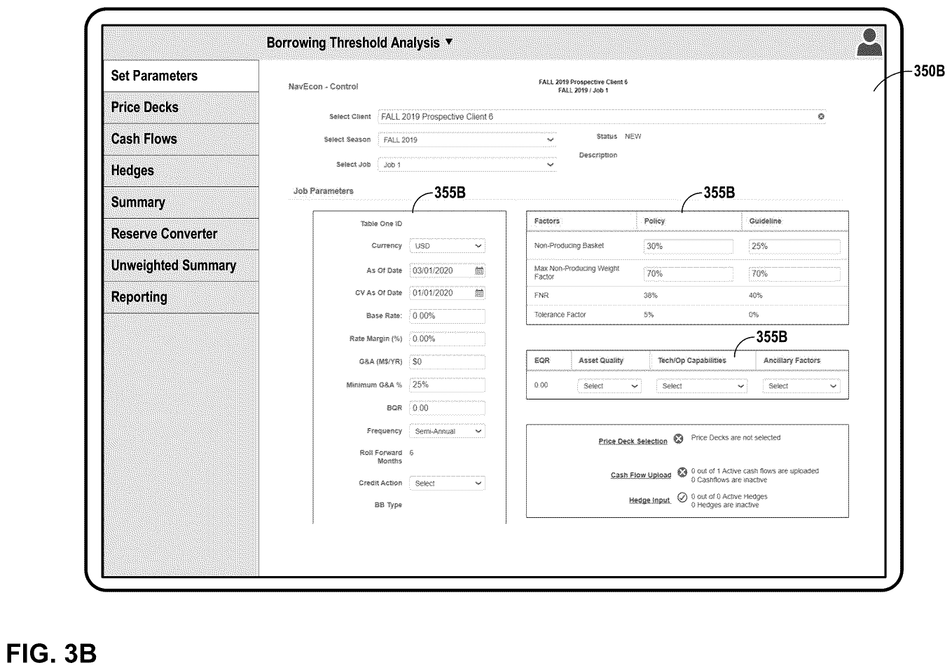

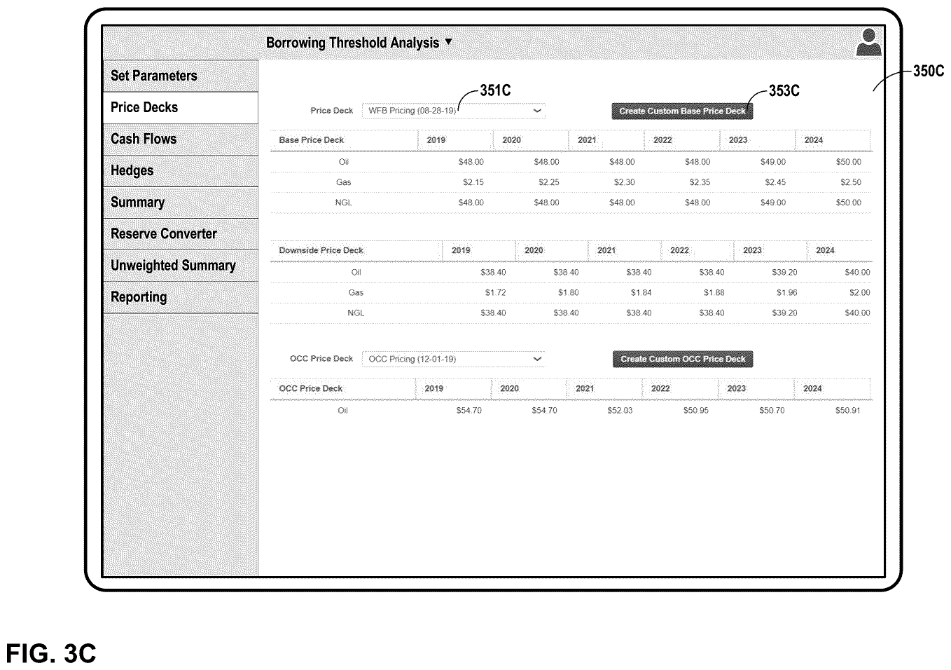

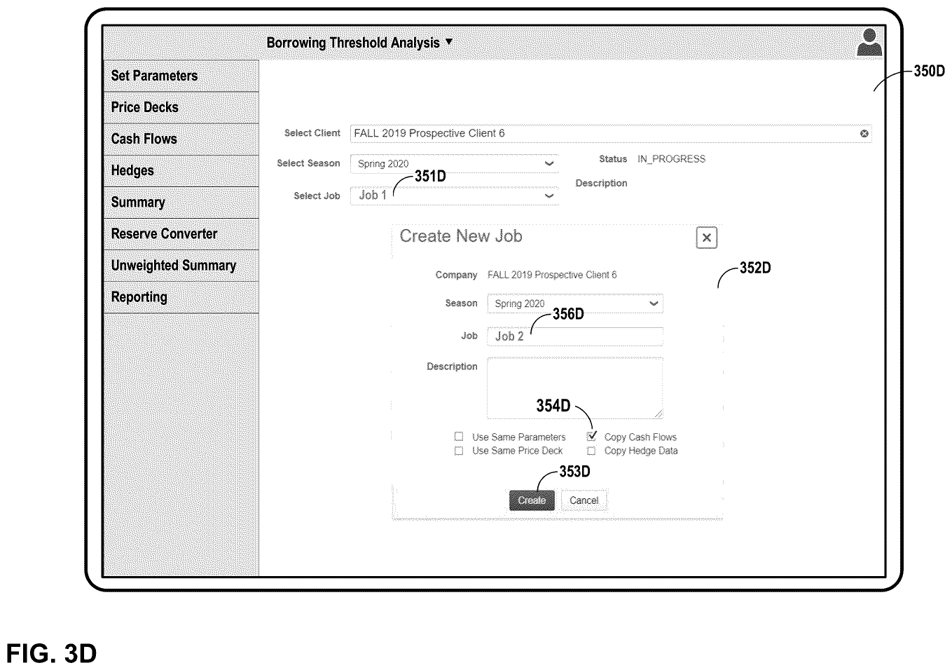

Administrator device 161 may collect parameters and price decks for calculating borrowing base data for one or more of entities 140. For instance, in an example that can be described in connection with FIG. 1A, administrator device 161 detects input (e.g., from administrator 162) that administrator device 161 determines corresponds to a request to determine borrowing base data for entity 140A. In response, administrator device 161 presents user interface 165, prompting administrator 162 for parameters and other information about the borrowing base to be determined for entity 140A. Administrator device 161 detects interactions with user interface 165. Based on the interactions, administrator device 161 generates parameter data 192. Parameter data 192 may include assumptions made in order to calculate a borrowing base, and may include information about the applicable time frame for determining the borrowing base data, as well as information about the account base rate, interest rates (LIBOR), and administrative expenses expected to be incurred by entity 140A. Parameter data 192 may also include (or may include references to) one or more price decks to be used for generating or calculating borrowing base data for entity 140A. Price decks are typically pricing forecasts over future timeframes for a number of commodities (see, e.g., an example price deck illustrated in user interface 350C of FIG. 3C). Such price decks may include price forecasts for the assets identified in energy asset data 191A for entity 140A.

Lender computing system 170 may use energy asset data 191A and parameter data 192 when calculating cash flow data 195A for entity 140A. For instance, continuing with the example being described with reference to FIG. 1A, administrator device 161 outputs a signal over network 132. Lender computing system 170 detects a signal over network 132, and determines that the signal includes parameter data 192 to be used for calculating borrowing base data for entity 140A. Lender computing system 170 uses energy asset data 191A (e.g., previously received from entity computing system 141A and stored by lender computing system 170) and parameter data 192 to determine expected cash flows associated with acquiring and developing the energy reserves held by entity 140A (i.e., identified in energy asset data 191A). Based on energy asset data 191A and parameter data 192, lender computing system 170 generates cash flow data 195A (corresponding to normalized or standardized cash flow data for entity 140A). In some examples, lender computing system 170 generates cash flow data 195A by causing commercially-available software (e.g., PHDwin, ARIES, or Val Nav) to process energy asset data 191A and parameter data 192 and thereby generate cash flow data 195A. Once generated, cash flow data 195A represents a standardized set of cash flows for entity 140A, describing revenue and costs for acquiring, developing, completing, and/or producing oil and gas reserves. Since cash flow data 195A is generated using price forecasts (i.e., the price decks included within parameter data 192), cash flow data 195A is significantly dependent upon those price forecasts. Lender computing system 170 may therefore include, within cash flow data 195A, cash flow data corresponding to multiple price decks, effectively providing a number of different cash flow scenarios. Such price decks may range from conservative to more aggressive forecasts, thereby providing corresponding cash flow information for entity 140A that ranges from conservative to more aggressive.

Lender computing system 170 may calculate borrowing base data 198A for one or more of entities 140. For instance, still referring to the example being described with reference to FIG. 1A, lender computing system 170 uses cash flow data 195A to generate borrowing base data 198A. To generate borrowing base data 198A, lender computing system 170 processes cash flow data 195A through complex algorithms to compute periodic production output schedules. In some examples, lender computing system 170 makes adjustments based on any hedging instruments that entity 140A may hold to offset risk in the expected production output. Such hedging instruments may be identified in energy asset data 191A. As a result of the calculations, lender computing system 170 formulates a range of present values. In some examples, lender computing system 170 may compute multiple borrowing base values, ranging from a safe lower range to a more aggressive, higher borrowing base value (e.g., each based on a different cash flow scenario included within cash flow data 195A). Once generated, borrowing base data 198A may be used by lender 160 or bankers employed by or partnering with lender 160 to make lending decisions.

Although lender computing system 170 is described as calculating borrowing base data 198 based on information associated with entity 140A, lender computing system 170 may alternatively, or in addition, perform calculations to generate borrowing base data 198 for one or more other entities 140 illustrated in FIG. 1A. In general, lender computing system 170 may perform similar calculations for such other entities 140, taking into account variances in how business records and other data is stored by each of entities 140. Accordingly, performing calculations for each of entities 140 may ultimately be similar, but may involve significant efforts to normalize and interpret energy asset data 191 received from each of entities 140.

Lender 160 may occasionally or periodically wish to recalculate borrowing base data 198 for one or more of entities 140 that have a lending relationship with lender 160. For instance, in some cases, lender 160 may routinely recalculate borrowing base data 198 for each of entities 140 that have a lending relationship with lender 160, in order to determine whether each of entities 140 is performing as expected, or whether an adjustment to borrowing base data 198 for one or more of entities 140 is warranted. For instance, if revenue projections for entity 140A later turn out to be overly optimistic, lender 160 may limit future lending to entity 140A; similarly, if revenue projections for entity 140A turn out to be overly pessimistic, lender 160 may consider increasing the credit extended to entity 140A. One or more of borrowing entities 140 may also inquire about how market changes or other events might affect their ability to access credit offered or extended by lender 160. In such a situation, lender 160 may cause lender computing system 170 to generate borrowing base data 198 for the inquiring borrowing entity 140 based on a fresh set of energy asset data 191 from the inquiring entity 140 and appropriate parameter data 192. Lender 160 may then respond to the inquiring borrowing entity 140 based on the newly-calculated borrowing base data 198. In general, lender 160 may frequently recalculate borrowing base data 198 for one or more of entities 140 for any of a number of reasons.

Accordingly, lender computing system 170 may perform calculations to determine new borrowing base data to assess a new scenario for one or more of entities 140. For instance, continuing with the prior example in which lender computing system 170 generated borrowing base data 198A for entity 140A, administrator device 161 detects input. Administrator device 161 determines that the input corresponds to a request to regenerate borrowing base data for entity 140A, using new parameters, a different price deck, and/or a different set of assumptions. Administrator device 161 outputs a signal over network 132. Lender computing system 170 detects a signal over network 132 and determines that the signal includes a new version of parameter data 192 (see “192′” in FIG. 1A), representing the new parameters, different prices or price decks, and/or different assumptions.

In some examples, to generate new borrowing base data (“borrowing base data 198A′” in FIG. 1A) for entity 140A based on these new assumptions, entity 140A may provide lender 160 with access to new energy asset data 191A′. Lender computing system 170 may then use this new 191A′ to generate new cash flow data 195A′ and borrowing base data 198A′ by applying the process described above. However, generating cash flow data 195A′ from the new energy asset data 191A′ received from entity 140A often requires significant processing, translation, and interpretation processes. As described above, these processes can be tedious, complicated, and time-consuming.

However, in accordance with one or more aspects of the present disclosure, and rather than require lender computing system 170 to regenerate new cash flow data 195A′ from new energy asset data 191A′, lender computing system 170 may modify previously-generated cash flow data 195A, rather than perform processing on energy asset data 191A′. For instance, in an example that can be described with reference to FIG. 1A, lender computing system 170 accesses the prior cash flow data 195A, which lender computing system 170 generated previously based on energy asset data 191A, as described above, when calculating borrowing base data 198A. Rather than regenerating a new cash flow data 195A′ from scratch using new energy asset data 191A′, lender computing system 170 modifies the previously-generated cash flow data 195A to estimate the effect of the new assumptions embodied in parameter data 192′. By modifying the previously-generated cash flow data 195A, lender computing system 170 may avoid at least some of the tedious, complicated, and time-consuming aspects of the previously-described process that may be required for generating new cash flow data 195A′ from energy asset data 191A′.

When modifying previously-generated cash flow data 195A to generate new cash flow data 195A′, lender computing system 170 performs an adjustment process for some or all of the cash flow items included within the previously-generated cash flow data 195A. For instance, the adjustment process may involve making an adjustment on a line-item-by-line-item basis for each of the items in cash flow data 195A (e.g., expenses, production amounts, values, taxes, costs, expenditures, revenues). For examples in which cash flow data 195A includes a number of cash flow projections, each corresponding to a different price deck, the adjustment process may involve performing a linear regression analysis (further described in connection with FIG. 1B) for each of the cash flow projections. In such an example, lender computing system 170 uses each of the cash flow projections included in previously-generated cash flow data 195A to estimate the value of each cash flow item in the new scenario. Lender computing system 170 thus uses the estimated cash flow items to generate cash flow data 195A′. Lender computing system 170 may also take into account effects of any hedging instruments entity 140A may hold to offset risk in the expected production outputs. Cash flow data 195A′ is thus derived from previously-generated cash flow data 195A, and represents an estimate of what cash flow data 195A would be using the new parameters, different price deck, and/or different set of assumptions. Yet cash flow data 195A′ is determined without requiring lender computing system 170 to fully regenerate from a new energy asset data 191A′ for the new parameters, different price deck, and/or different set of assumptions.

FIG. 1B is a graph illustrating a linear regression analysis that may be performed to estimate the value of a cash flow item using cash flow data associated with four different price decks. The process described with respect to FIG. 1B may be applied to some or all of the cash flow items in cash flow data 195A to translate cash flow data 195A into cash flow data 195A′, as described in FIG. 1A.

In FIG. 1B, values for a particular cash flow item are plotted on the y-axis of graph 120. The cash flow item in FIG. 1B could be any cash flow item included in cash flow data 195A described in connection with FIG. 1A. For example, the cash flow item illustrated may be an expense value, a production amount, a tax value, cost value, expenditure, revenue amount, or any other appropriate cash flow item.

FIG. 1B illustrates cash flow item values for each of four price decks. For values calculated in cash flow data 195A using the first price deck, the price of oil at a particular time is forecasted to be $42, and the corresponding cash flow item (calculated when generating cash flow data 195A) is approximately $10 (see point 121A). For values in cash flow data 195A using the second price deck, the price of oil at the same time is forecasted to be $44, and the corresponding cash flow item (calculated when generating cash flow data 195A) is approximately $22 (see point 121B). For values calculated in cash flow data 195A using the third price deck, the price of oil at the relevant time is forecasted to be $46, and the corresponding cash flow item has a value if approximately $15 (see point 121C). For values calculated in cash flow data 195A using the third price deck, the price of oil at the relevant time is forecasted to be $48, and the corresponding cash flow item has a value if approximately $33 (see point 121D).

Linear regression line 125, determined through a linear regression analysis using the four points 121A, 121B, 121C, and 121D, can be used to estimate the value of the same cash flow item for a new, different price deck. For instance, if lender computing system 170 seeks to determine the value of the cash flow item when the value of oil at the relevant time is $45—a price not represented in the four price decks associated with cash flow data 195A—linear regression line 125 suggests that the value of that cash flow item can be estimated to be $20. As shown in FIG. 1B, the regression line passes through the point represented by an oil value of $45 and a cash flow item value of $20. A linear regression analysis, such as that illustrated in FIG. 1B, can be used to estimate the values of cash flow items for cash flow data 195A′ using data from previously-generated cash flow data 195A.

The techniques described herein may provide certain technical advantages. For instance, in examples where calculations are performed based on adjustments made to cash flow data generated in a prior analysis, significant computing cycles may be saved, since such calculations may often be performed much more efficiently. Further, by performing calculations based on such adjustments, significant additional processing may be avoided entirely, including processing to normalize, interpret, and/or transform business data that might be received from a borrowing entity or prospective borrowing entity. Such processing may require not only significant computing resources, but also skilled human intervention in many cases. Performing calculations based on a prior analysis can therefore result in accurate or sufficiently accurate results with fewer calculations, less processing requirements, and less human intervention.

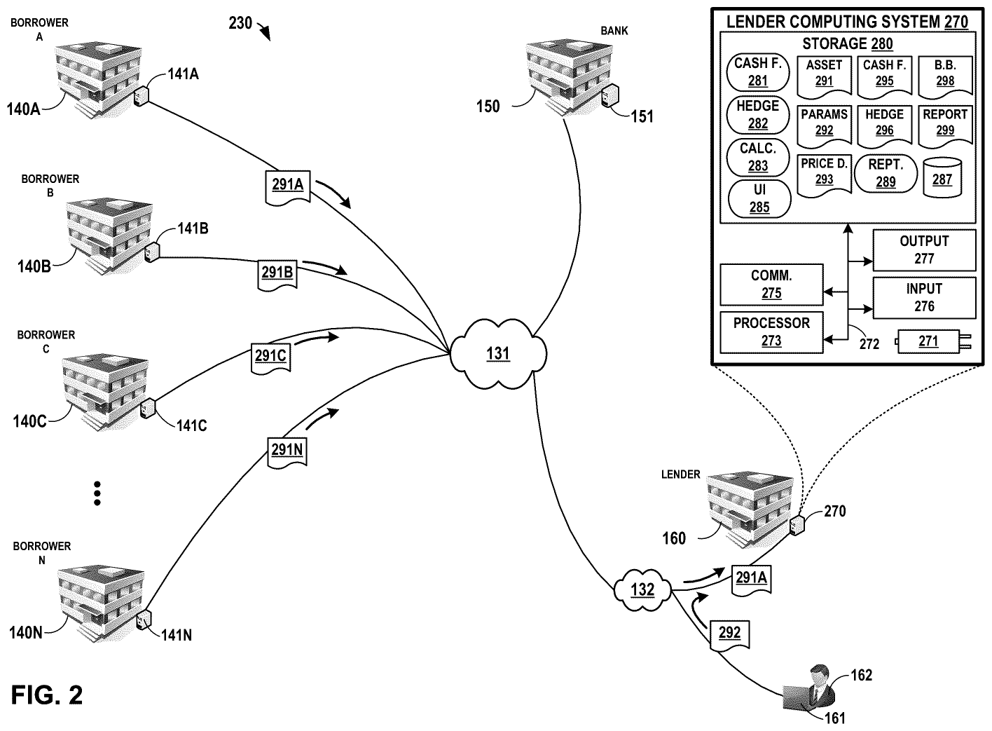

FIG. 2 is a block diagram illustrating an example system for analysis of property interests, reserves, and cash flows for a plurality of entities in the petroleum energy industry, in accordance with one or more aspects of the present disclosure. System 230 may be described as an example or alternative implementation of system 130 of FIG. 1A. One or more aspects of FIG. 2 may be described herein within the context of FIG. 1A.

FIG. 2 is similar in many respects to FIG. 1A, and includes entities 140A, 140B, 140C, through 140N (collectively “entities 140”), along with corresponding entity computing systems 141A, 141B, 141C, through 141N, each controlled by a respective entity 140. FIG. 2 also includes bank 150 and banking system 151 as well as lender 160. Lender 160 owns, controls, or otherwise has access to administrator device 161, which may correspond to administrator device 161 described in connection with FIG. 1A. Lender 160 also owns, controls, or otherwise has access to lender computing system 270. In some examples, lender computing system 270 may correspond to lender computing system 170 described and illustrated in FIG. 1A. Each of such systems is capable of communicating over networks 131 and 132.

In general, systems, devices, or components illustrated in FIG. 2 may correspond to like-numbered systems, devices, or components illustrated in FIG. 1A, and may be implemented in a manner consistent with the description provided in connection with FIG. 1A. Such systems may be implemented in a manner consistent with the description of the corresponding system provided in connection with FIG. 1A, although in some examples such systems may involve alternative implementations with more, fewer, and/or different capabilities. For ease of illustration, and in at least some cases, only one system of a given type is illustrated in FIG. 2 (e.g., one lender computing system 270 is shown in FIG. 2, and one entity computing system 141 is shown associated with each of entities 140), although techniques in accordance with one or more aspects of this disclosure may be performed with many more of such systems.

Lender computing system 270 may be implemented as any suitable computing system, such as one or more server computers, workstations, mainframes, appliances, cloud computing systems, virtual machines, containers, and/or other computing systems that may be capable of performing operations and/or functions described in accordance with one or more aspects of the present disclosure. In some examples, lender computing system 270 represents a cloud computing system, server farm, and/or server cluster (or portion thereof) that provides services to client devices and other devices or systems. In other examples, lender computing system 270 may represent or be implemented through one or more virtualized compute instances (e.g., virtual machines, containers) of a data center, cloud computing system, server farm, and/or server cluster.

In the example of FIG. 2, lender computing system 270 may include power source 271, one or more processors 273, one or more communication units 275, one or more input devices 276, and one or more output devices 277, and one or more storage devices 280. Storage devices 280 may include cash flow module 281, hedge analysis module 282, calculation engine module 283, user interface module 285, reporting module 289, and data store 287. Storage device 280 and/or data store 287 included within storage device 280 may store other instances of data as described herein, including one or more instances of energy asset data 291, parameter data 292, price deck data 293, cash flow data 295, hedge adjustments data 296, borrowing base data 298, and/or reports 299. One or more of the devices, modules, storage areas, or other components of lender computing system 270 may be interconnected to enable inter-component communications (physically, communicatively, and/or operatively). In some examples, such connectivity may be provided by through communication channels (e.g., communication channels 272), a system bus, a network connection, an inter-process communication data structure, or any other method for communicating data.

Power source 271 may provide power to one or more components of lender computing system 270. Power source 271 may receive power from the primary alternating current (AC) power supply in a building, home, or other location. In other examples, power source 271 may be a battery or a device that supplies direct current (DC). In still further examples, lender computing system 270 and/or power source 271 may receive power from another source. One or more of the devices or components illustrated within lender computing system 270 may be connected to power source 271, and/or may receive power from power source 271. Power source 271 may have intelligent power management or consumption capabilities, and such features may be controlled, accessed, or adjusted by one or more modules of lender computing system 270 and/or by one or more processors 273 to intelligently consume, allocate, supply, or otherwise manage power.

One or more processors 273 of lender computing system 270 may implement functionality and/or execute instructions associated with lender computing system 270 or associated with one or more modules illustrated herein and/or described below. One or more processors 273 may be, may be part of, and/or may include processing circuitry that performs operations in accordance with one or more aspects of the present disclosure. Examples of processors 273 include microprocessors, application processors, display controllers, auxiliary processors, one or more sensor hubs, and any other hardware configured to function as a processor, a processing unit, or a processing device. Lender computing system 270 may use one or more processors 273 to perform operations in accordance with one or more aspects of the present disclosure using software, hardware, firmware, or a mixture of hardware, software, and firmware residing in and/or executing at lender computing system 270.

One or more communication units 275 of lender computing system 270 may communicate with devices external to lender computing system 270 by transmitting and/or receiving data, and may operate, in some respects, as both an input device and an output device.

In some examples, communication unit 275 may communicate with other devices over a network. In other examples, communication units 275 may send and/or receive radio signals on a radio network such as a cellular radio network. In other examples, communication units 275 of lender computing system 270 may transmit and/or receive satellite signals on a satellite network such as a Global Positioning System (GPS) network. Examples of communication units 275 include a network interface card (e.g. such as an Ethernet card), an optical transceiver, a radio frequency transceiver, a GPS receiver, or any other type of device that can send and/or receive information. Other examples of communication units 275 may include devices capable of communicating over Bluetooth®, GPS, NFC, ZigBee, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth, NFC, or other technologies or protocols.

One or more input devices 276 may represent any input devices of lender computing system 270 not otherwise separately described herein. One or more input devices 276 may generate, receive, and/or process input from any type of device capable of detecting input from a human or machine. For example, one or more input devices 276 may generate, receive, and/or process input in the form of electrical, physical, audio, image, and/or visual input (e.g., peripheral device, keyboard, microphone, camera).

One or more output devices 277 may represent any output devices of lender computing system 270 not otherwise separately described herein. One or more output devices 277 may generate, receive, and/or process input from any type of device capable of detecting input from a human or machine. For example, one or more output devices 277 may generate, receive, and/or process output in the form of electrical and/or physical output (peripheral device, actuator). Some devices may serve as both input and output devices. For example, a communication device may both send and receive data to and from other systems or devices over a network.

One or more storage devices 280 within lender computing system 270 may store information for processing during operation of lender computing system 270. Storage devices 280 may store program instructions and/or data associated with one or more of the modules described in accordance with one or more aspects of this disclosure. One or more processors 273 and one or more storage devices 280 may provide an operating environment or platform for such modules, which may be implemented as software, but may in some examples include any combination of hardware, firmware, and software. One or more processors 273 may execute instructions and one or more storage devices 280 may store instructions and/or data of one or more modules. The combination of processors 273 and storage devices 280 may retrieve, store, and/or execute the instructions and/or data of one or more applications, modules, or software. Processors 273 and/or storage devices 280 may also be operably coupled to one or more other software and/or hardware components, including, but not limited to, one or more of the components of lender computing system 270 and/or one or more devices or systems illustrated as being connected to lender computing system 270.

In some examples, one or more storage devices 280 are temporary memories, meaning that a primary purpose of the one or more storage devices is not long-term storage. Storage devices 280 of lender computing system 270 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Storage devices 280, in some examples, also include one or more computer-readable storage media. Storage devices 280 may be configured to store larger amounts of information than volatile memory. Storage devices 280 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories.

Cash flow module 281 may perform functions relating to generating cash flow data 295 from a combination of energy asset data 291, parameter data 292, and price deck data 293. In some examples, cash flow module 281 may generate cash flow data 295 from a previously-generated cash flow data 295 by making modifications to the previously-generated cash flow data 295 consistent with new parameter data 292 and/or price deck data 293, or other information.

Hedge analysis module 282 may perform functions relating to generating hedge adjustments data 296 from energy asset data 291, cash flow data 295, parameter data 292, and/or price deck data 293. In some examples, hedge analysis module 282 may generate hedge adjustments data 296 from previously-generated cash flow data 295 by making modifications to the previously-generated cash flow data 295 consistent with new parameter data 292 and/or price deck data 293, or other information.

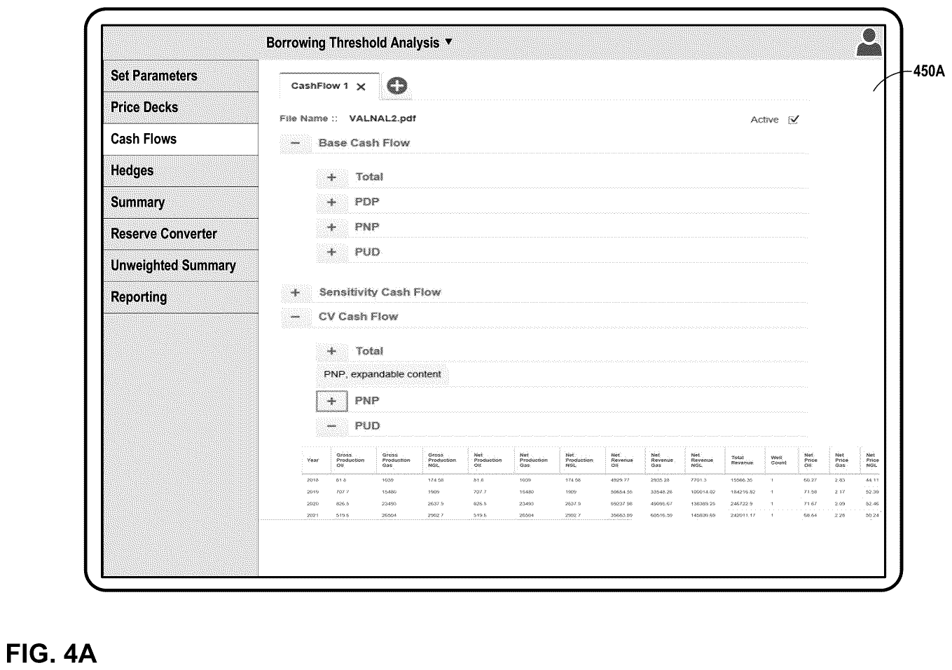

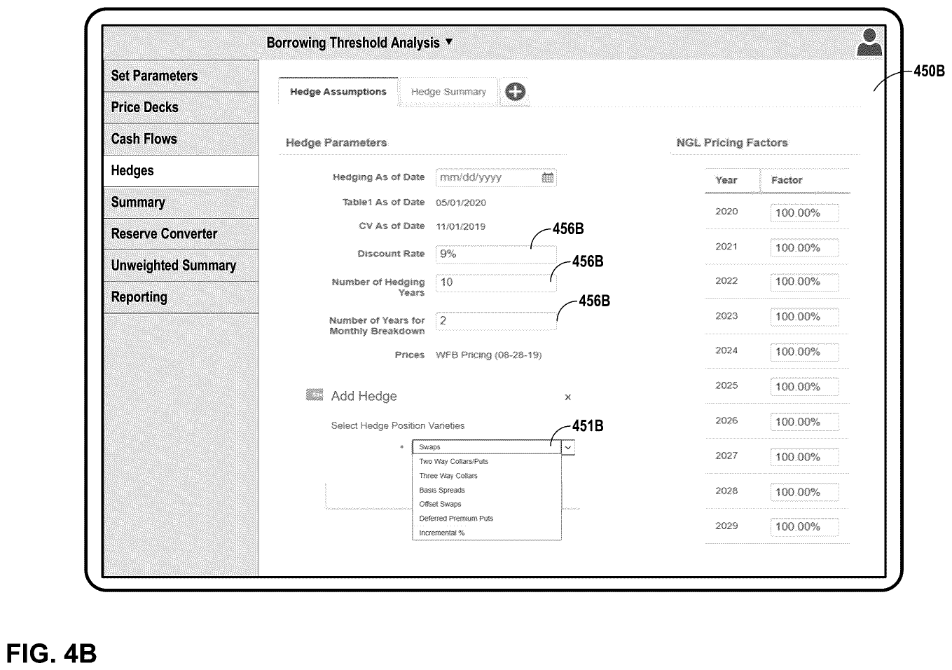

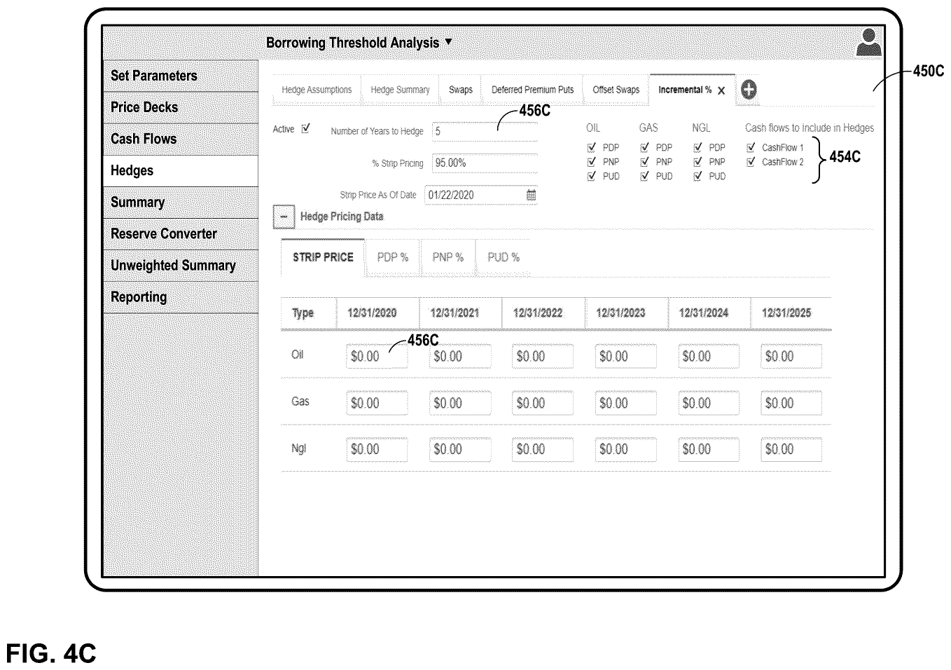

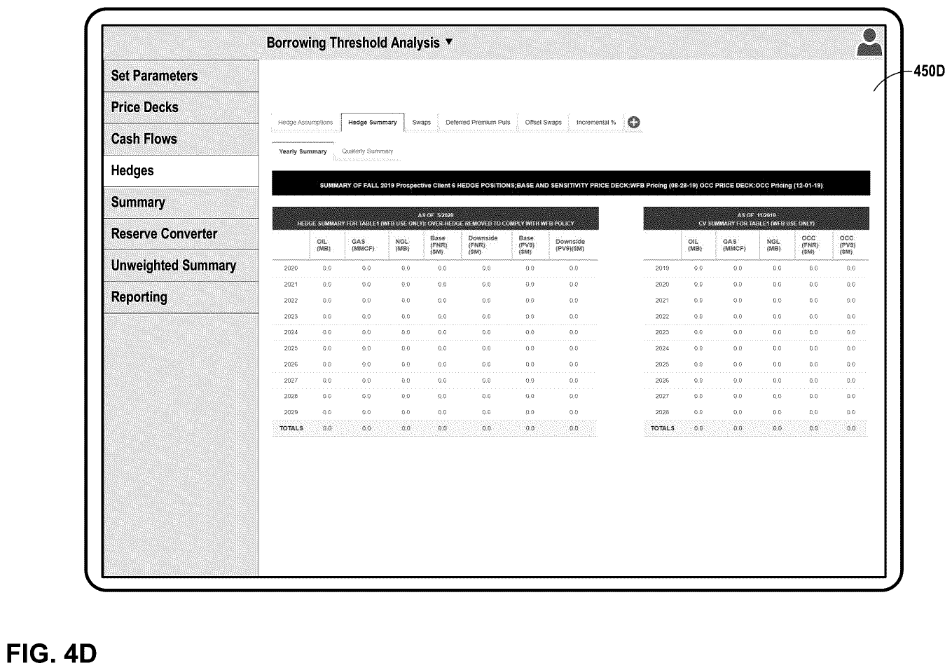

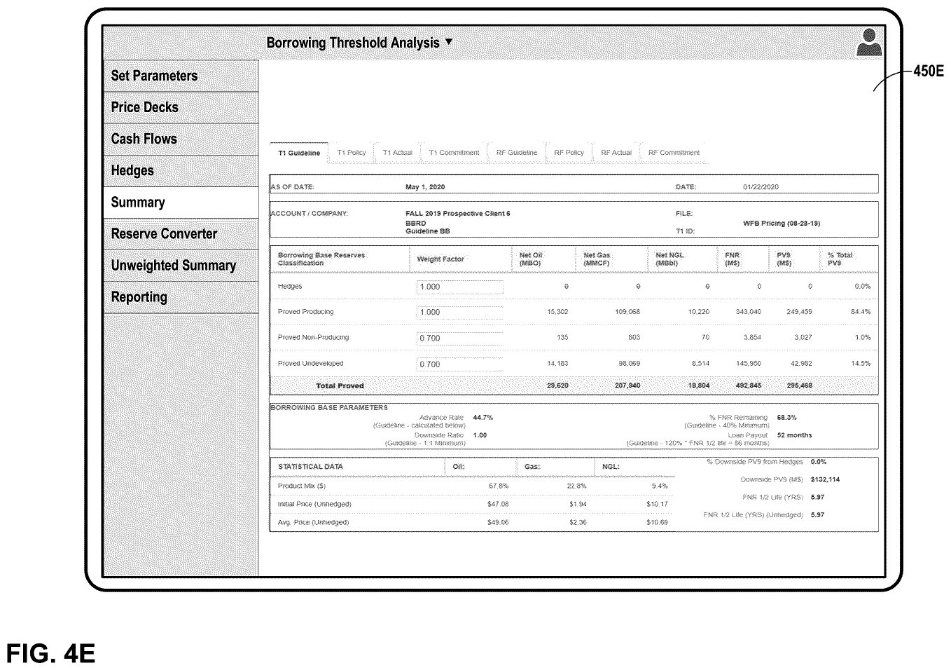

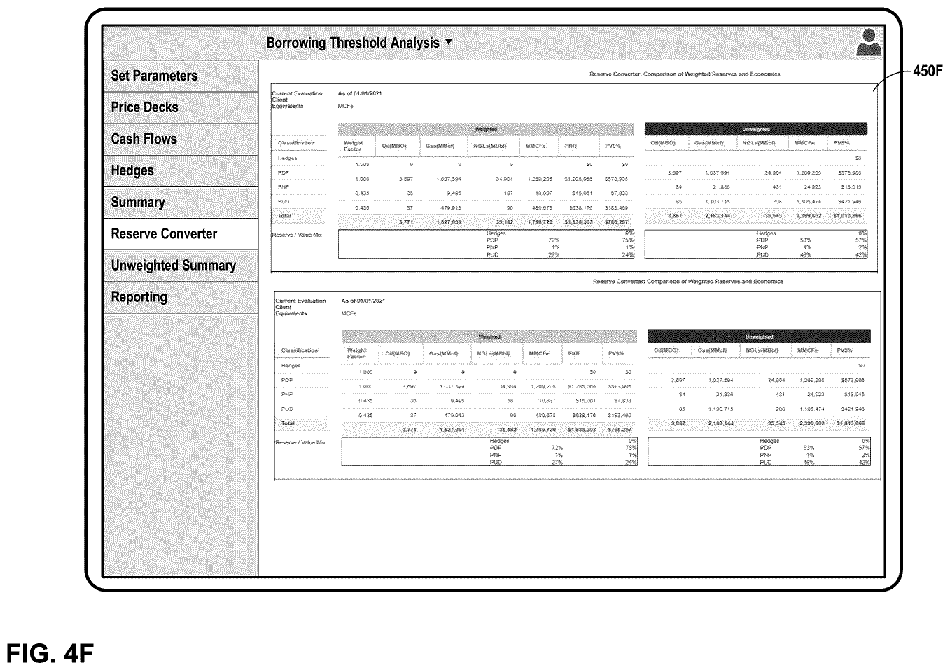

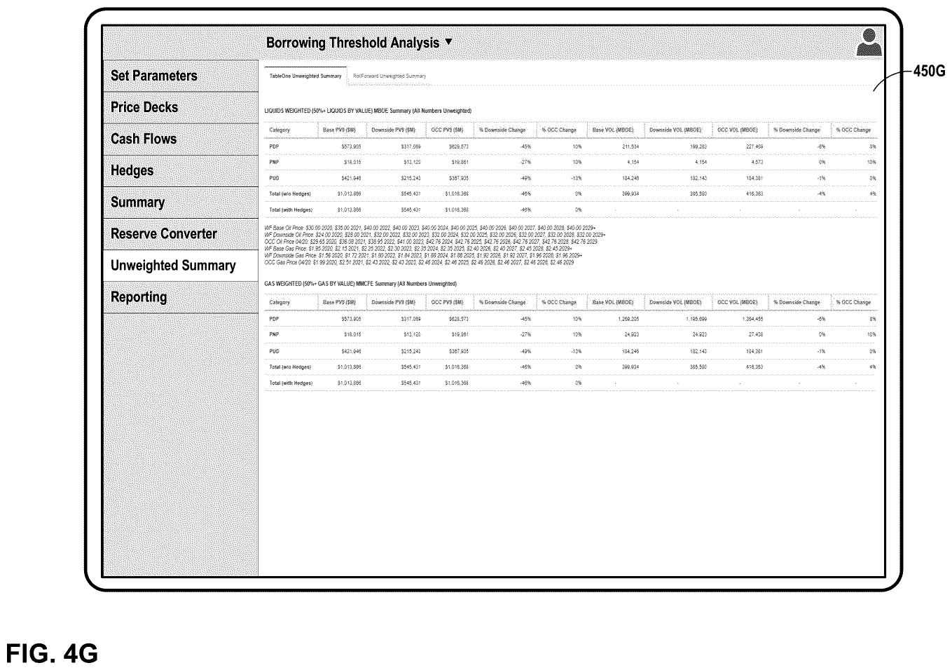

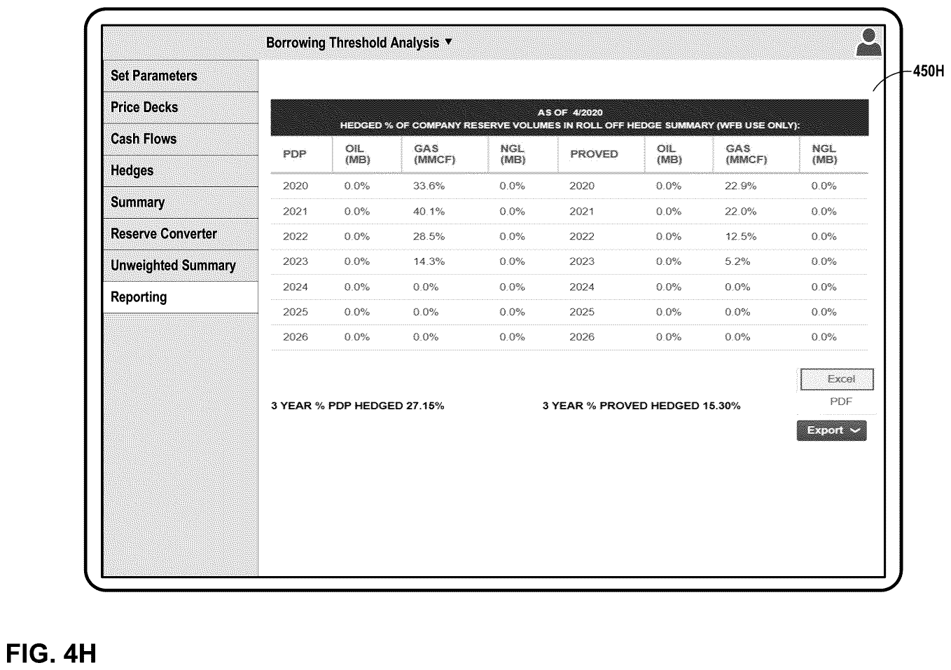

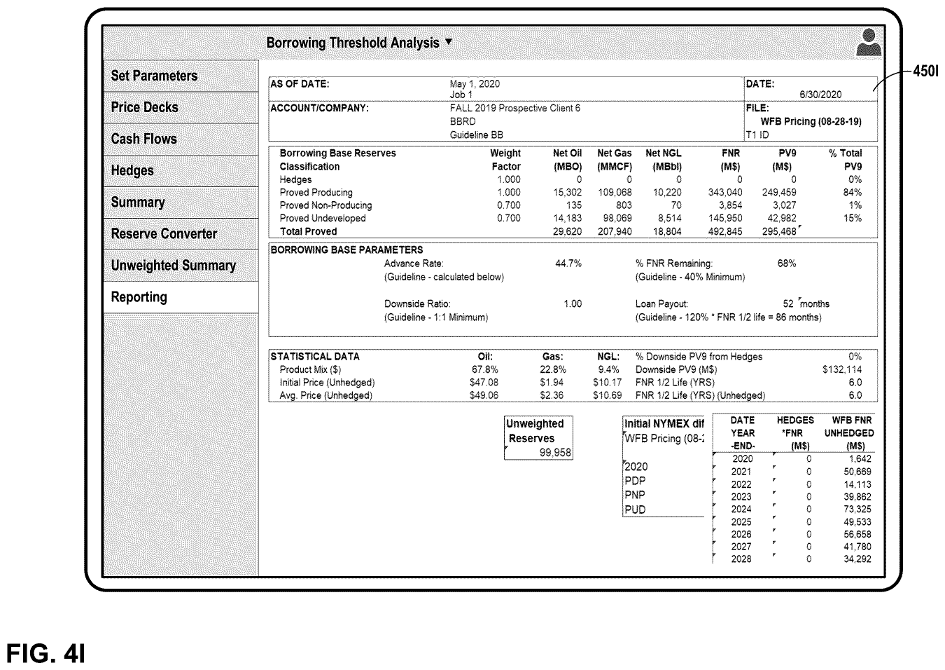

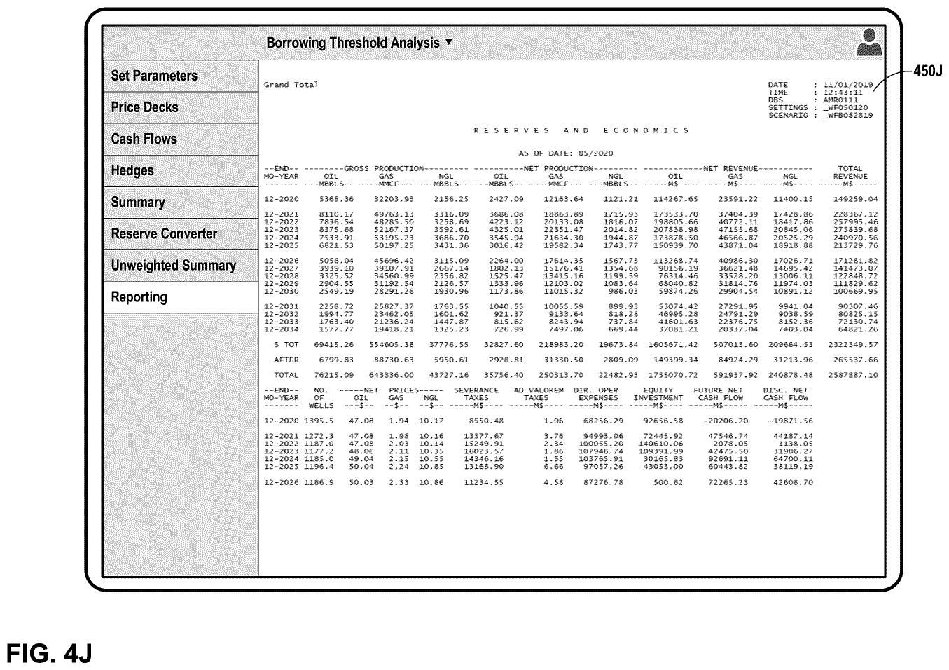

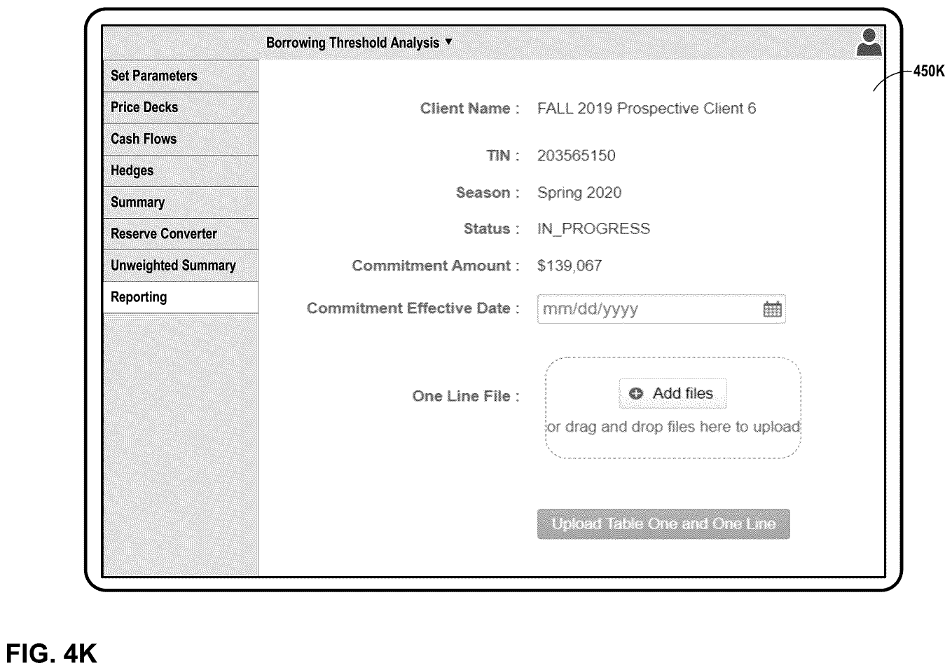

Calculation engine module 283 may perform functions relating to generating borrowing base data 298 from cash flow data 295 and hedge adjustments data 296. User interface module 285 may perform functions relating to generating user interfaces that prompt a user (e.g., administrator 162 operating administrator device 161) for parameters, price deck choices, and other information. User interface module 285 may also perform functions relating to presenting information to such a user, such as reporting information (see, e.g., FIG. 4H, FIG. 4I, FIG. 4J, and FIG. 4K). Reporting module 289 may perform functions relating to generating reporting information, often preparing reports 299 of results of processing by calculation engine module 283.

Data store 287 may represent any suitable data structure or storage medium for storing information relating to records of one or more entities 140 or other information pertinent to analysis of energy assets as described herein. Data store 287 may be primarily maintained by calculation engine module 283 and/or reporting module 289. Data store 287 may provide other modules with access to the data stored within data store 287, and/or may analyze the data stored within data store 287 and output such information on behalf of other modules of lender computing system 270.

Modules illustrated in FIG. 2 (e.g., cash flow module 281, hedge analysis module 282, calculation engine module 283, user interface module 285, reporting module 289) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

FIG. 3A through FIG. 3D are conceptual diagrams illustrating example user interfaces presented by a user interface device in accordance with one or more aspects of the present disclosure. The user interfaces illustrated in FIG. 3A through FIG. 3D may correspond to a user interface presented by administrator device 161 of FIG. 1A and FIG. 2. Although the user interfaces illustrated in FIG. 3A through FIG. 3D are shown as graphical user interfaces, other types of interfaces may be presented by administrator device 161 or other devices, including a text-based user interface, a console or command-based user interface, a voice prompt user interface, or any other appropriate user interface. One or more aspects of the user interfaces illustrated in FIG. 3A through FIG. 3D may be described herein within the context of system 230 of FIG. 2.

FIG. 3A illustrates an example user interface that may be presented by a computing device when initiating the calculation of borrowing base information for a borrowing entity, in accordance with one or more aspects of the present disclosure. For instance, with reference to an example that can be described in the context of FIG. 2, administrator device 161 detects input that it determines corresponds to a request to calculate a borrowing threshold for one of entities 140. Administrator device 161 outputs a signal over network 132. Communication unit 275 of lender computing system 270 detects a signal over network 132 and outputs an indication of the signal to user interface module 285. User interface module 285 determines that the signal corresponds to a request to create a new job for calculating a borrowing threshold. User interface module 285 generates information for a user interface prompting a user to enter information for the new job. User interface module 285 causes communication unit 275 to output a signal over network 132. Administrator device 161 detects a signal over network 132 and determines that the signal includes information sufficient to present a user interface. Administrator device 161 uses the information to present user interface 350A at a display associated with administrator device 161 in the manner illustrated in FIG. 3A.

In FIG. 3A, user interface 350A includes a number of input fields, including drop-down box 351A enabling selection of one of entities 140 for calculating borrowing base information. Additional drop-down boxes within user interface 350A enable selection of a time frame and season. User interface 350A also includes dialog box 352A, enabling additional information to be entered and/or selected relevant to the selected entity 140. Dialog box 352A includes a number of checkboxes 354A and button 353A, selectable by a user (e.g., administrator 162) to create a new job. Note that in the example of FIG. 3A, the user is creating “Job 1” associated with “Prospective Client 6” (e.g., entity 140A) and none of checkboxes 354A are checked.

Lender computing system 270 may create a new job for calculating a borrowing base for entity 140A. For instance, referring again to the example being described in the context of FIG. 2, administrator device 161 detects input corresponding to selection of button 353A in user interface 350A of FIG. 3A. Administrator device 161 outputs a signal over network 132. Communication unit 275 of lender computing system 270 detects a signal and outputs information about the signal to user interface module 285. User interface module 285 determines that the signal corresponds to a request to create a job to calculate a borrowing base for “Prospective Client 6,” which in the example being described, is assumed to correspond to entity 140A. User interface module 285 causes “Job 1” to be created, and stores information relating to the new job in data store 287.

Lender computing system 270 may request information from entity 140A about assets held by entity 140A. For instance, still referring to FIG. 2, cash flow module 281 determines that a new job has been created to calculate borrowing base data for entity 140A. In response, cash flow module 281 causes communication unit 275 to output a signal over network 132 and network 131. Entity computing system 141A detects the signal and responds by transmitting energy asset data 291A over network 131 and network 132. Communication unit 275 of lender computing system 270 detects a signal and outputs information about the signal to cash flow module 281. Cash flow module 281 determines that the information corresponds to energy asset data 291A from entity 140A. In some examples, cash flow module 281 may process energy asset data 291A to transform energy asset data 291A into a format suitable for use with commercially available software for generating a set of cash flows representing the oil and gas assets held by entity 140A. In some cases, such a transformation may involve significant processing and/or human intervention, as described above in connection with processing of energy asset data 191A.

FIG. 3B illustrates an example user interface that may be presented by a computing device that is collecting parameters for use in calculating borrowing base information for a borrowing entity, in accordance with one or more aspects of the present disclosure. For instance, referring again to the example being described in the context of FIG. 2, and responsive to new “Job 1” being created, user interface module 285 generates data for a user interface prompting a user to enter parameter information for the newly-created job. User interface module 285 causes communication unit 275 to output a signal over network 132. Administrator device 161 detects the signal and determines that the signal includes information sufficient to present a user interface. Administrator device 161 uses the information to present user interface 350B at a display in the manner illustrated in FIG. 3B.

In FIG. 3B, user interface 350B includes a number of input areas 355B, enabling entry of various parameters relevant to calculating a borrowing base. Such parameters may include the relevant date(s) for the borrowing base, the base rate and rate margin, information about general and administrative expenses for entity 140A (“Prospective Client 6”), information about the borrower quality rating (“BQR”), and roll-forward information. Such parameters may also include other information, such as information about how various factors differ based on policy and guideline calculations.

Lender computing system 270 may store information entered into user interface 350B by a user as parameter data 292. For instance, referring again to FIG. 2, administrator device 161 detects input indicating that parameters have been configured within user interface 350B of FIG. 3B. Administrator device 161 outputs a signal over network 132 that is detected by communication unit 275 of lender computing system 270. User interface module 285 of lender computing system 270 determines that the signal includes parameter information corresponding to information entered into user interface 350B when user interface 350B was presented at administrator device 161. User interface module 285 causes the parameter information to be stored at lender computing system 270 as parameter data 292. In some examples, parameter data 292 may also be stored in data store 287.

FIG. 3C illustrates an example user interface that may be presented by a computing device to enable configuration or selection of a price deck for use in calculating borrowing base information for a borrowing entity, in accordance with one or more aspects of the present disclosure. For instance, referring to FIG. 2 and FIG. 3C, user interface module 285 determines that parameter data 292 has been configured and stored at lender computing system 270. In response, user interface module 285 causes communication unit 275 to output information over network 132. Administrator device 161 detects the information and determines that the information is sufficient to present a user interface. Administrator device 161 presents user interface 350C at a display in the manner illustrated in FIG. 3C.

In FIG. 3C, user interface 350C includes information about price decks to be used in calculating a borrowing base for entity 140A. When calculating borrowing base information, lender computing system 170 uses a price deck to place a value on oil, gas, and NGL assets that entity 140A is producing or is expected to produce. Such a price deck enables lender computing system 170 to forecast the value of such assets, as adjusted by any hedging strategies that may be employed by entity 140A. Based on the forecasted prices in a price deck, asset values will change correspondingly, and therefore the value of various assets held by entity 140A (as associated cash flows) will also change. User interface 350C enables selection of any of a number of price decks through drop-down box 351C. Selection of button 353C enables creation of custom price decks, such as those developed by bank 150 or lender 160 or by a third party (e.g., a current NYMEX futures curve). To develop such a custom price deck, for example, lender 160 may apply a discount to the current NYMEX futures curve. Lender 160 may also consider industry price deck surveys in developing a price deck. In some examples, price decks extending ten years or more into the future can be used, which may significantly enhance accuracy and reliability of borrowing base calculations and/or hedging adjustments. (Although only six years are shown in user interface 350C, other user interfaces contemplated by this disclosure may accommodate ten years or more.)

Generally, multiple price decks are used to calculate multiple sets of borrowing base information. Borrowing base information can range from conservative to more aggressive, based on price decks ranging from conservative to more aggressive.

Lender computing system 270 may store price deck information as price deck data 293. For instance, referring again to FIG. 2 and FIG. 3C, administrator device 161 detects input indicating that a user of administrator device 161 (e.g., administrator 162) has finalized selection of the desired price deck(s). Administrator device 161 outputs a signal over network 132 that is received by lender computing system 270, and that user interface module 285 determines includes price deck selection information. User interface module 285 stores the price deck information as price deck data 293. In some examples, price deck data 293 may be stored in data store 287.

Lender computing system 270 may calculate cash flow data 295. For instance, referring again to the example being described in the context of FIG. 2, cash flow module 281 determines that both parameter data 292 and price deck data 293 have been configured, and that energy asset data 291A is available. In response to such a determination, cash flow module 281 processes energy asset data 291A based on parameter data 292 and price deck data 293 to generate a set of cash flows. Cash flow module 281 stores information about the cash flows as cash flow data 295. In some examples, cash flow module 281 may be or may include third-party, commercially available software (e.g., PHDwin, Val Nav, Aries) for generating cash flow information corresponding to the oil and gas assets held by entity 140A. In some cases, calculating cash flow data 295 may require that cash flow module 281 perform significant transformations on energy asset data 291A received from entity 140A, and such transformation may involve significant and skilled human intervention in order to properly perform processes, translations, interpretation steps, and accounting adjustments. Such transformations may be needed to organize, standardize, and/or normalize the data representing assets held by entity 140A. Such transformation may be necessary in order to use third-party software for generating cash flow information, and therefore, such transformation may be necessary even when commercially available software is used to calculate cash flow data 295.

Lender computing system 270 may calculate hedge adjustments data 296. For instance, referring again to the example being described in the context of FIG. 2, hedge analysis module 282 determines that energy asset data 291A includes information about hedges held by entity 140A. In response to such a determination, hedge analysis module 282 identifies any information about hedge positions included within energy asset data 291A. Typically, one or more of entities 140 may employ hedging strategies to manage commodity price volatility. Commodity hedging may be used by entity 140A as a risk management tool to help ensure stable and predictable cash flow, maintain liquidity, and manage credit risk. In some examples, hedge instruments used by entities 140 may include forwards, futures, swaps, options, or combinations, such as collars.

If entity 140A employs such strategies, information about the hedging strategies employed may be included in energy asset data 291A. Hedge analysis module 282 processes energy asset data 291A based on parameter data 292 and price deck data 293 to interpret and generate standardized information about the hedging strategies employed by entity 140A. Hedge analysis module 282 uses the generated information to create hedge adjustments data 296. If entity 140A does not employ any such strategies, hedge analysis module 282 might not need to perform any processing. Accordingly, operations performed by parameter data 292 may be optional or not needed in some scenarios.

Lender computing system 270 may calculate borrowing base data 298 from cash flow data 295 and hedge adjustments data 296. For instance, still referring to the example being described in the context of FIG. 2, calculation engine module 283 determines that both cash flow data 295 and hedge adjustments data 296 have been generated. Calculation engine module 283 calculates borrowing base data 298 based on cash flow data 295 while also using any hedge adjustments data 296 to make adjustments appropriate for hedging strategies employed by entity 140A. For example, hedge positions held by entity 140A are incorporated into cash flow forecasts and reserve valuations, and such hedge positions may affect how borrowing base data 298 is calculated. In some examples, hedge positions may provide increased borrowing base capacity. Calculation engine module 283 may also take into account preferences and/or policies implemented by lender 160 that pertain to hedging strategies used by entities 140. For example, if entity 140A is hedging too much or in an inefficient way, calculation engine module 283 may adjust borrowing base data 298 accordingly, which may involve reducing a borrowing base value used for lending decisions with respect to entity 140A. Once calculated, borrowing base data 298 may be used by lender 160 (or bank 150) for providing a borrowing certification.

In general, calculations performed by calculation engine module 283 may take into account many factors, in addition to those described above. Some of the factors include: an estimate of how much oil, gas, and natural gas liquids can be recovered from a given location with at least a 90% certainty of successful economic recovery; Proven Developed Producing Reserves; Proven Developed Nonproducing Reserves; Proven Undeveloped Reserves; Future Net Revenues; Present Value of all Future Net Revenue discounted to 9%; capital expenditures required to develop reserves; operating expenses associated with producing reserves and maintaining ongoing production; a primary price deck commonly used by lender 160 for estimating the value of assets held by entities 140 or entity 140A specifically; collateral values; general and administrative expense associated with day to day operating of a business; the starting date from which all summary calculations are referenced; the maximum percentage of the present value the lender is willing to extend for a loan; the ratio of the total sensitivity; the percentage of the company's Future Net Revenue that is still to be realized after a 15 year period from the starting date; the estimated number of months until the company's Future Net Revenue has reduced the loan balance to zero; the percent interest rate at which the loan will be made to the client company; the percent added or subtracted to the market rate of the loan to provide a return to the lender 160; the Weight Factor multiplier required so that total Proved Developed Producing Reserves and Proved Undeveloped Reserves comprises no more than 25% (Guideline) or 30% (Policy) of the total; the time (in years) for half of the client's projected Future Net Reserves to be realized; reserve volumes and values that do not take the Weight Factor into account; Roll Forward, which uses a 6 month (or user specified) period from as of date to produce a second set of Tables to indicate the future of the client's values; a Cash Flow document produced from one of the engineering software systems that summarizes production and revenue. In some cases, such factors also include the discretion of agents of lender 160 (e.g., resource base lending engineers or bankers) in choosing which one or more price decks to apply in a given situation.

FIG. 3D illustrates an example user interface, similar to FIG. 3A, that may be presented by a computing device to create a new job, in accordance with one or more aspects of the present disclosure. For instance, referring again to the example being described in the context of FIG. 2, administrator device 161 detects input and outputs a signal over network 132. Communication unit 275 detects the signal and user interface module 285 of lender computing system 270 determines that the signal corresponds to a request to create a new job. Communication unit 275 outputs a signal over network 132 that administrator device 161 uses to present user interface 350D at a display in the manner illustrated in FIG. 3D.

In FIG. 3D, a user of administrator device 161 (e.g., administrator 162) interacts with user interface 350D to request that a new job (“Job2” as specified in field 356D of dialog box 352D of user interface 350D) be created that is based on previously-generated “Job 1” (see drop-down box 351D in FIG. 3D). In this new job, administrator 162 is initiating calculation of updated borrowing base data 298 for entity 140A that is based on new assumptions, new parameters, and/or new price decks. Note that checkboxes 354D in FIG. 3D specify that the previously-calculated “Cash Flows,” corresponding to previously-calculated cash flow data 295, are to be used when generating a new borrowing base data 298 (see “Copy Cash Flows” checkbox 354D). Also note that in the example being described, previously-calculated “Hedge Data,” corresponding to hedge adjustments data 296, is not being used for Job 2 (see “Copy Hedge Data” checkbox 354D).

In response to interactions with user interface 350D, lender computing system 270 may create a new job. For instance, still referring to the example being described in the context of FIG. 2, administrator device 161 detects input that it determines corresponds to interactions with FIG. 3D. Administrator device 161 outputs a signal over network 132. Communication unit 275 of lender computing system 270 detects a signal over network 132 that user interface module 285 determines corresponds to information about the interactions and configurations made in user interface 350D by a user of administrator device 161. Responsive to the signal, user interface module 285 creates a new job (“Job 2”).

User interface module 285 then causes user interfaces similar to user interface 350B and 350C (see FIG. 3B and FIG. 3C) to be presented to at administrator device 161. In response to interactions with such user interfaces, user interface module 285 outputs to calculation engine module 283 information about updated parameter data 292 and price deck data 293 for Job 2.

Calculation engine module 283 generates updated cash flow data 295 by modifying previously-generated cash flow data 295 (created in Job 1). To modify the previously-generated cash flow data 295, calculation engine module 283 performs an adjustment process, on a cash flow item by cash flow item basis, for each of the cash flow items included within previously-generated cash flow data 295. The adjustment process may be similar to or correspond to the process described above in connection with FIG. 1A and FIG. 1B. Such a process may involve a linear regression analysis using the data included within the previously-generated cash flow data 295 for multiple price decks.

Lender computing system 270 may generate updated borrowing base data 298 using the updated cash flow data 295. For instance, still referring to FIG. 2, calculation engine module 283 outputs information about updated cash flow data 295 to hedge analysis module 282. Hedge analysis module 282 uses updated cash flow data 295 to generate updated hedge adjustments data 296, reflecting modifications to the assumptions embodied in updated cash flow data 295. In some examples, hedging information and its effect on the values of reserves held by entity 140A may be change based on the updated cash flow data 295. In the example being described, hedge analysis module 282 generates hedge adjustments data 296 directly from available data, and hedge analysis module 282 does not need to estimate hedge adjustments data 296 from prior-calculated data, or perform any interpolation, linear regression analysis, or data transformation in order to generate updated hedge adjustments data 296. In other examples, however, hedge analysis module 282 may use an interpolation or linear regression analysis that is analogous to that performed by calculation engine module 283 when generating updated cash flow data 295. Calculation engine module 283 generates updated borrowing base data 298 using both updated cash flow data 295 and updated hedge adjustments data 296.

Lender computing system 270 may publish or otherwise make borrowing base data 298 available for use by bank 150 and/or lender 160. For instance, referring once more to FIG. 2, administrator device 161 detects input that administrator device 161 determines corresponds to a request to generate a report based on the newly calculated borrowing base data 298.

Administrator device 161 outputs a signal over network 132. Communication unit 275 of lender computing system 270 detects a signal over network 132 and outputs information about the signal to user interface module 285. User interface module 285 determines that the signal corresponds to a request by a user at administrator device 161 (e.g., administrator 162) to generate a report. User interface module 285 outputs information about the request to reporting module 289. Reporting module 289 accesses borrowing base data 298 (or updated borrowing base data 298) and generates one or more reports 299. Reporting module 289 causes communication unit 275 to output information about reports 299 over network 132.

Administrator device 161 detects a signal over network 132 and determines that the signal includes reporting information. Administrator device 161 generates one or more user interfaces and presents them at a display associated with administrator device 161. In some examples, the user interfaces may have a form similar to that illustrated in FIG. 4H, FIG. 4I, and/or FIG. 4J. Administrator 162 may share reporting information with bankers or other agents of bank 150 and/or lender 160 for use in making lending decisions.

The example described in connection with FIG. 3A through FIG. 3D illustrates how updated cash flow data 295 for entity 140A may be generated in a streamlined and more efficient manner using previously-generated cash flow data 295 for entity 140A. In other examples, it may be possible for updated cash flow data 295 or even new cash flow data 295 to be generated for entity 140A in a similarly streamlined manner using previously-generated cash flow data 295 for a different one of entities 140, such as, for example, entity 140B or entity 140C. Such a process may be particularly appropriate or applicable if business operations, energy reserve holdings, and/or hedging strategies employed by entity 140B are similar or otherwise correspond to those of entity 140A.

FIG. 4A through FIG. 4K are conceptual diagrams illustrating example user interfaces that may be presented by a user interface device in accordance with one or more aspects of the present disclosure. The user interfaces illustrated in FIG. 4A through FIG. 4K may correspond to user interfaces presented by administrator device 161 of FIG. 2 during a process for calculating a borrowing base, such as that described above with reference to FIG. 2 and FIG. 3A through FIG. 3D. As with FIG. 3A through FIG. 3D, the user interfaces illustrated in FIG. 4A through FIG. 4K are shown as graphical user interfaces, but other types of interfaces may be appropriate, including a text-based user interfaces, command-based user interfaces, voice prompt user interfaces, or others.

FIG. 4A illustrates an example user interface that presents information about cash flow processing performed by an example cash flow module, in accordance with one or more aspects of the present disclosure. In FIG. 4A, user interface 450A includes information how cash flow data 295 was calculated for a given entity 140 and includes information about the results of the calculation. For example, user interface 450A includes information a base cash flow, a sensitivity cash flow, and a collateral value (CV) cash flow. For each, a breakdown is provided for the proved developed producing (PDP) reserves, the proved non-producing (PNP) reserves, and the proved undeveloped (PUD) reserves. In each case, user interface 450A may respond to user interface interactions requesting expansion of a header (“Total,” “PNP,” “PUD”) by presenting a table of information, as shown in the lower portion of user interface 450A.

FIG. 4B illustrates an example user interface that may be presented by a computing device to illustrate calculations relating to hedge processing, in accordance with one or more aspects of the present disclosure. In FIG. 4B, user interface 450B provides a number of fields 456B, enabling a user (e.g., administrator 162) to specify assumptions pertaining to hedges held by the entity 140 being considered. As shown in various fields 456 of FIG. 4B, a discount rate can be specified, along with the number of years for which hedging effects are consider, and a number of years for which a monthly breakdown is generated (e.g., for reporting purposes). Drop-down box 451B enables a user to add hedge information by specifying a particular variety of hedge being used by a specific entity 140.

FIG. 4C illustrates an example user interface that may be presented by a computing device to illustrate and/or enable editing of strip prices used in calculations relating to hedge processing, in accordance with one or more aspects of the present disclosure. In FIG. 4C, user interface 450C provides a number of fields 456C enabling configuration of hedge processing. Checkboxes 454C enable a user to select or specify which reserves and/or cash flows have relevant hedge considerations and which should be included in hedging calculations. User interface 450C also provides, in the table in the lower portion of user interface 450C, a number of strip price fields 456, enabling adjustment or modification of strip prices to use when calculating hedge adjustments data 296. Although only a few years are shown in user interface 450C, a strip price extending ten years or more may be used when determining the effect of hedging strategies, if sufficient computing resources are made available to lender computing system 270 for such calculations. Long range forecasting (e.g., ten years or more) may result in more accurate assessment of hedging strategies, and more accurate and reliable borrowing base assessments.

FIG. 4D illustrates an example user interface that may be presented by a computing device to illustrate a summary of calculations (sometimes referred to as a “Table One” or “T1” summary) relating to hedge processing, in accordance with one or more aspects of the present disclosure. In FIG. 4D, user interface 450D includes a table that provides a hedge summary that includes annual projections over a time period of ten years or longer. A table for two different time periods is presented in user interface 450D, including a time period corresponding to the current date and a time period six months into the future (e.g., a “roll forward” date).

FIG. 4E illustrates an example user interface that may be presented by a computing device to illustrate a summary of borrowing base calculations, in accordance with one or more aspects of the present disclosure. FIG. 4F illustrates an example user interface that may be presented by a computing device to illustrate a comparison of weighted and unweighted reserves calculations, in accordance with one or more aspects of the present disclosure. FIG. 4G illustrates an example user interface that may be presented by a computing device to illustrate a comparison of unweighted reserves calculations, in accordance with one or more aspects of the present disclosure.

FIG. 4H illustrates an example user interface that may be presented by a computing device to illustrate reporting information pertaining to PDP (proved developed producing) reserves, in accordance with one or more aspects of the present disclosure. FIG. 4I and FIG. 4J each illustrate an example user interface that may present a report summarizing borrowing base information, in accordance with one or more aspects of the present disclosure. FIG. 4K illustrates an example user interface that may be presented by a computing device to enable storage of data pertaining to a set of borrowing base calculations, in accordance with one or more aspects of the present disclosure.

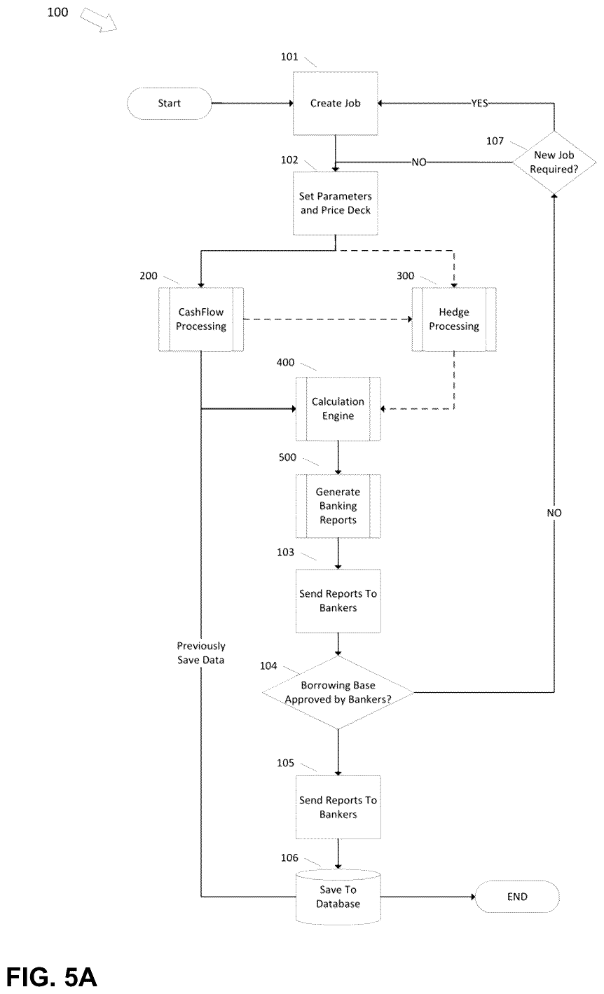

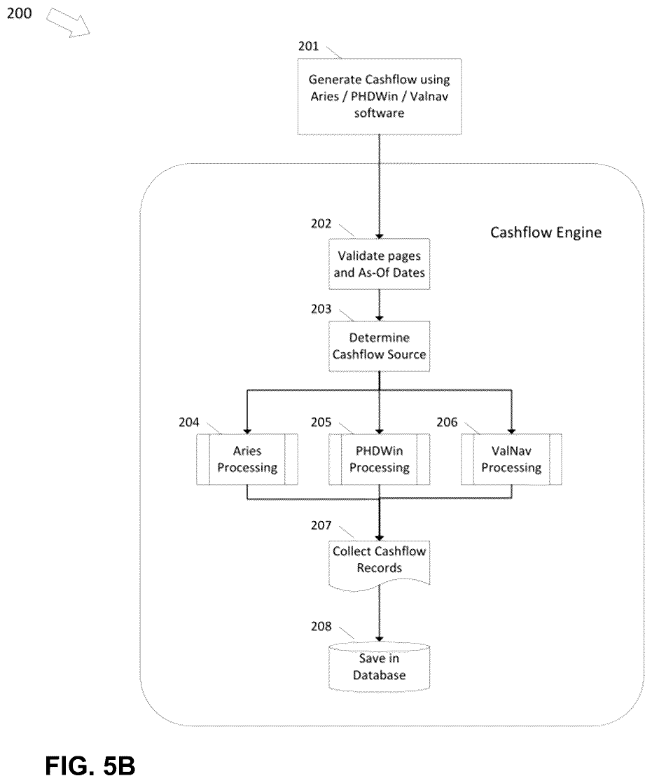

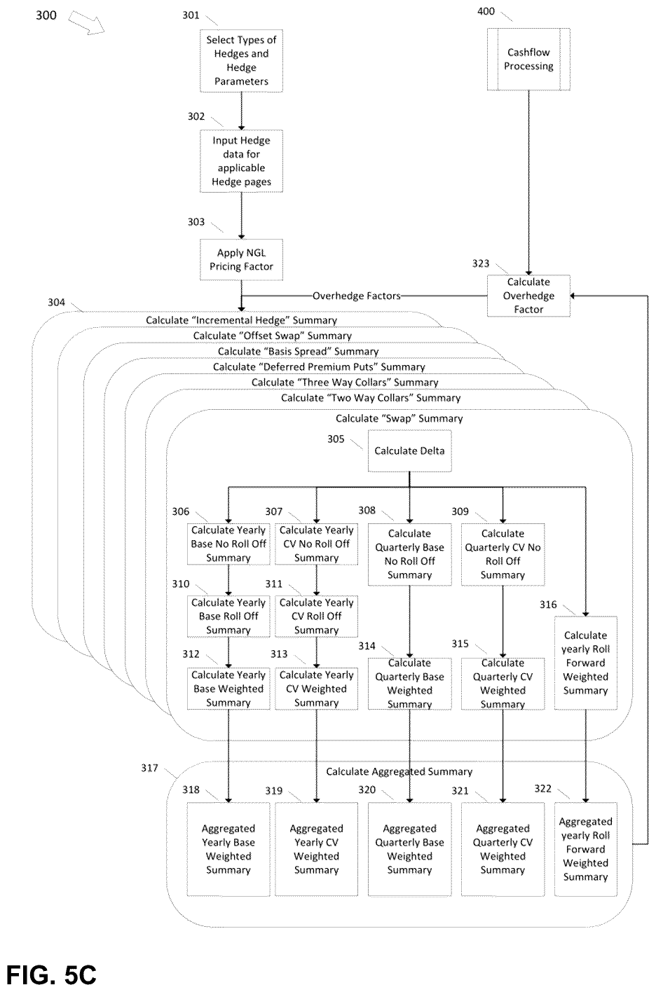

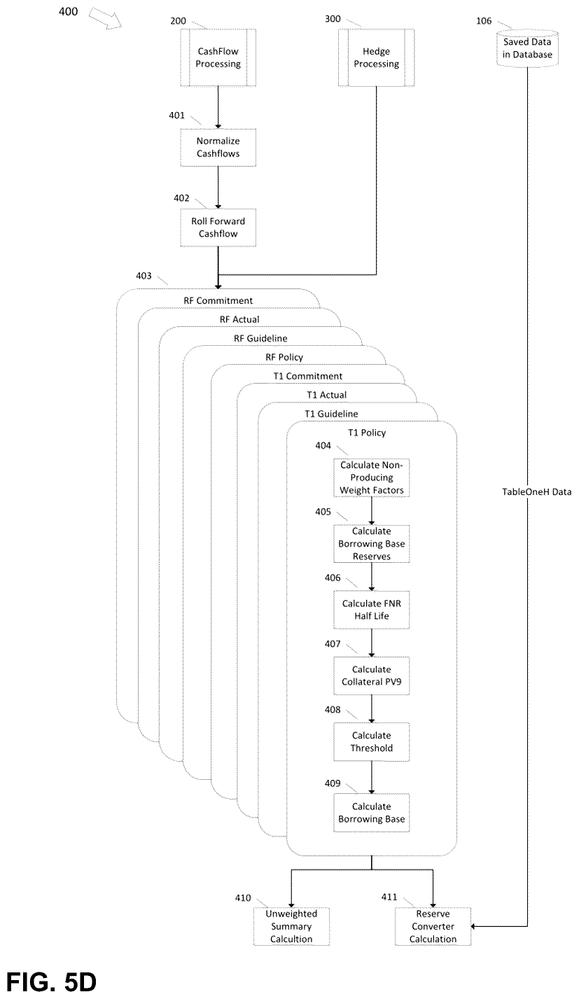

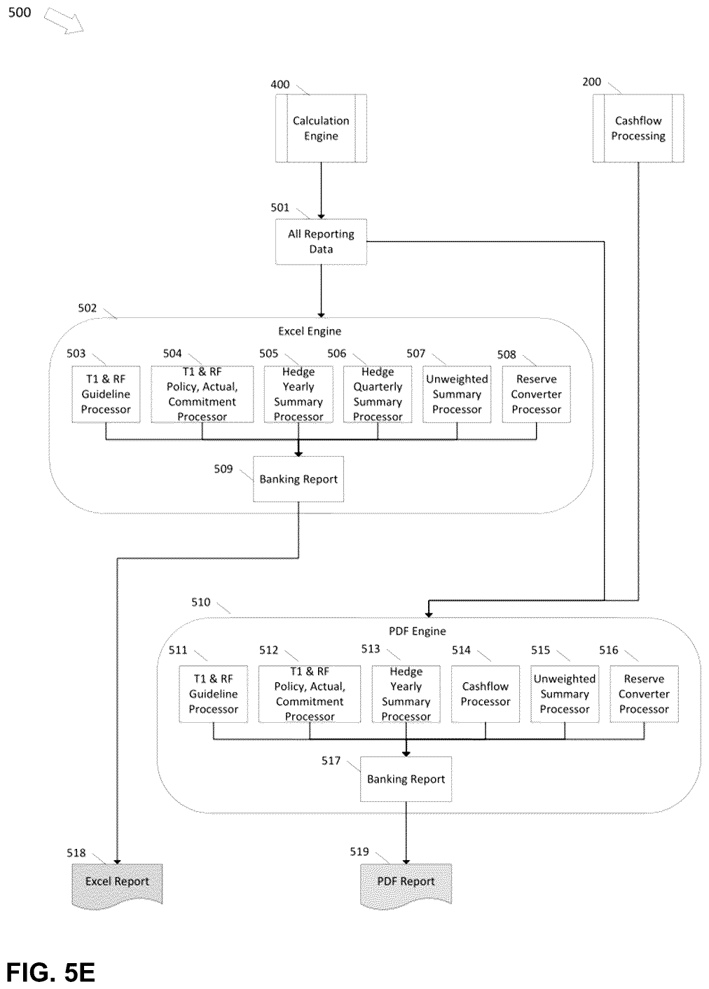

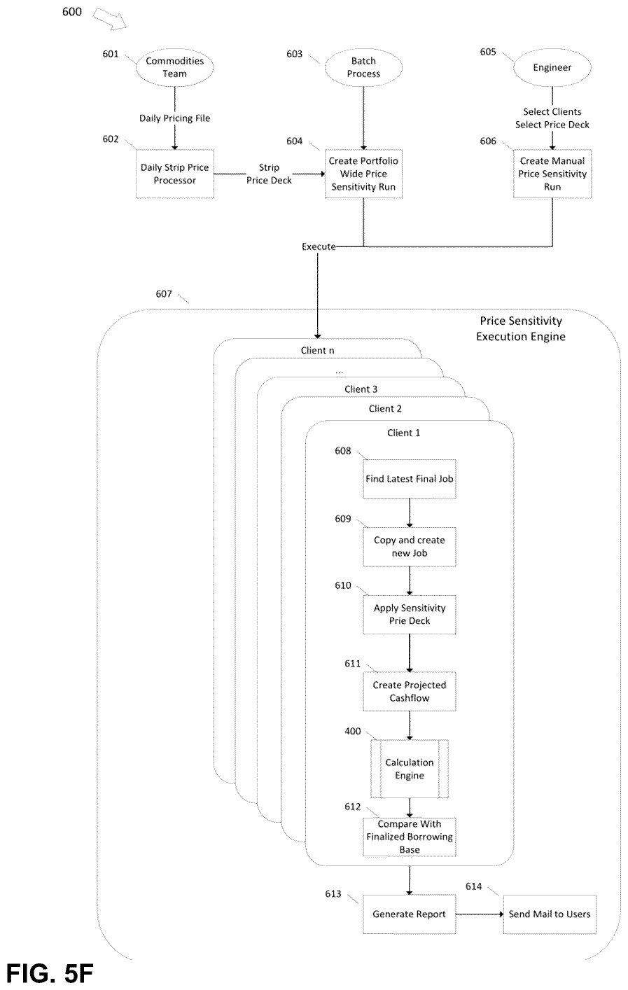

FIG. 5A through FIG. 5F are flow diagrams illustrating operations performed by an example computing system in accordance with one or more aspects of the present disclosure. Each of FIG. 5A through FIG. 5F illustrate operations that may correspond to the descriptions of operations described above being performed by lender computing system 170 of FIG. 1A (or by lender computing system 270 of FIG. 2). For context, FIG. 5A through FIG. 5F are described below in the context of example operations performed by lender computing system 170 of FIG. 1A. However, the operations, procedures, and steps specifically illustrated in FIG. 5A through FIG. 5F are illustrative, and one or more of the operations, procedures, and steps shown in FIG. 5A through FIG. 5F may be merged, performed in a difference sequence, omitted, and/or may encompass additional operations not specifically illustrated or described.

In general, FIG. 5A illustrates a process for generating borrowing base data based on energy asset data associated with one or more of entities 140. Such information is used to create reports, some of which may be used by bankers to make lending decisions, in accordance with one or more aspects of the present disclosure.

In FIG. 5A, an in accordance with one or more aspects of the present disclosure, lender computing system 170 may create a job (101). For instance, lender computing system 170 may receive input over network 132 from administrator device 161 indicating that a user of administrator device 161 (e.g., administrator 162) seeks to create a job.

Lender computing system 170 may set parameters and a price deck (102). For instance, lender computing system 170 may receive, from one of entities 140, information about energy assets held by that borrowing entity 140. Lender computing system 170 may also cause a series of user interfaces to be presented at administrator device 161 (see, e.g., FIG. 3B and FIG. 3C), enabling administrator 162 to provide parameter data and price deck data for use in calculating borrowing base data for borrowing entity 140.

Lender computing system 170 may perform cash flow processing (200), and lender computing system 170 may optionally perform hedge processing (300). For instance, lender computing system 170 uses energy asset data received from borrowing entity 140 along with the parameters and price deck data to generate cash flow data. Lender computing system 170 may optionally use that same energy asset data along with the parameters and price deck data to generate hedge adjustments data, to the extent that borrowing entity 140 has engaged in any hedging strategies or holds any hedging assets.

Lender computing system 170 may process the results of the cash flow processing and the hedge processing with a calculation engine (400). For instance, lender computing system 170 may use the data generated as a result of the cash flow processing and hedge processing to generate borrowing base data. Lender computing system 170 may use the generated borrowing base data to generate reports (500), which may be distributed to bankers (103). Bankers may, on the basis of such reports, approve the borrowing base (104). If not approved, however, a new job may be created (107). Reports and other data associated with the generated borrowing base data may be stored in a database (106).

FIG. 5B is a flow chart illustrating more details about the cash flow processing operations identified as block 200 in FIG. 5A. In the example illustrated in FIG. 5B, lender computing system 170 uses commercially-available software (e.g., Aries, PHDwin, Val Nav) to generate cash flow information (204, 205, 206). The records generated by such software are collected as cash flow records (corresponding to cash flow data 195A of FIG. 1A), and are stored in a database (208).

FIG. 5C is a flow chart illustrating more details about the hedge processing operations identified as block 300 in FIG. 5A. In the example of FIG. 5C, lender computing system 170 receives input from administrator device 161 indicating information about the types of hedges and hedge parameters being employed by borrowing entity 140 (301). Lender computing system 170 may identify a number of different hedging strategies being employed by borrowing entity 140. Lender computing system 170 processes the input to categorize the hedging strategies (302). Lender computing system 170 may apply any applicable pricing factors (303). For each hedging strategy being employed by borrowing entity 140, lender computing system 170 applies the one of the processes 304. In other words, FIG. 5C illustrates a number of different types of hedging strategies (e.g., “incremental hedge,” “offset swap,” “basis spread,” “deferred premium puts,” “three way collars,” “two way collars,” and “swap.” Each of these hedging strategy types is represented in FIG. 5C as a layer (“304”) of processing. Each layer 304 (each corresponding to a different type of strategy) performs the operations 305-316 illustrated in FIG. 5C. Accordingly, for a “swap” strategy, lender computing system 170 calculates delta (305), and performs additional calculations called out in blocks 306 to 316. Similarly, each of the other layers 304 perform similar operations for each different type of hedging strategies employed by borrowing entity 140. The results of the processing by each layer are used to calculate an aggregated summary (317) detailed in operations 318 through 322.

FIG. 5D is a flow chart illustrating more details about the calculation engine processing identified as block 400 in FIG. 5A. In the example of FIG. 5D, lender computing system 170 processes the results of blocks 200 and 300 to ultimately generate an unweighted summary calculation (410) and a reserve converter calculation (411) (see, e.g., FIG. 4F and FIG. 4G). After normalizing the cash flows and the roll-forward (RF) cash flows from block 200 (401 and 402), lender computing system 170 performs each of the processes 403, once for eight different types of calculations pertinent to generating borrowing base data. As illustrated in FIG. 5D, the processes are characterized as: RF Commitment, RF Actual, RF Guideline, RF Policy, Summary or (“T1”) Commitment, Summary Actual, Summary Guideline, and Summary Policy. The process performed by each type corresponds to the illustrated operations 404 to 409.

FIG. 5E is a flow chart illustrating more details about the reporting operations identified in block 500 of FIG. 5A. Lender computing system 170 may use the results of block 400 to generate various reports, which may include the information illustrated in FIG. 5E. In some cases, such reports may be generated in formats (e.g., Microsoft Excel or PDF) convenient for sharing with end users or bankers.

FIG. 5F is a flow chart illustrating how a portfolio-wide sensitivity check may be performed across all entities 140 for which lender 160 has a lending relationship, in accordance with one or more aspects of the present disclosure. Each entity 140 with which lender 160 has a lending relationship may be periodically evaluated to determine whether the assumptions and business operations undertaken by each entity 140 are consistent with expectations and previous calculations. Such an evaluation may involve generating borrowing base data based on updated energy asset data for each such entity 140. One way to generate updated borrowing base data is to generate new cash flow data based on updated energy asset data. However, such a process may be complex, tedious, and time-consuming, as previously described. FIG. 5F illustrates an alternative and more efficient approach, where previously-generated cash flow data for each of entities 140 is adjusted based on new assumptions, parameters, or price decks. Such adjustments may be performed in a manner consistent with the adjustments described in connection with FIG. 1B.

For each of entities 140 (“Client 1 through Client n”) in FIG. 5F, lender computing system 170 identifies the latest job completed for that entity 140 (608). Lender computing system 170 copies and creates a new job (609). Lender computing system 170 applies a sensitivity price deck, which may be a new, updated price deck for which borrowing base data is to be calculated (610). Lender computing system 170 generates adjusted cash flow data, applying any applicable hedging information (611). Lender computing system 170 applies process 400 (see FIG. 4D) to the adjusted cash flow data to generate updated borrowing base data. Lender computing system 170 may compare the results to the prior calculations (612). Lender computing system 170 may generate and distribute reports (613 and 614).

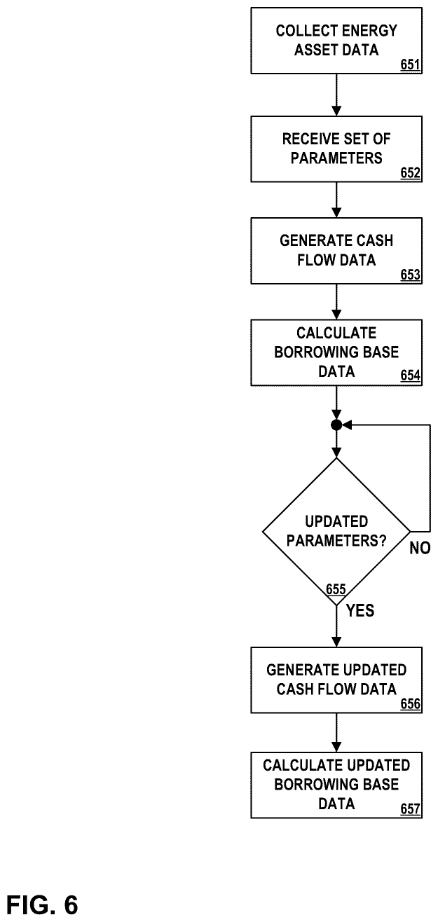

FIG. 6 is a flow diagram illustrating operations performed by an example lender computing system in accordance with one or more aspects of the present disclosure. FIG. 6 is described below within the context of lender computing system 170 of FIG. 1A. In other examples, operations described in FIG. 6 may be performed by one or more other components, modules, systems, or devices. Further, in other examples, operations described in connection with FIG. 6 may be merged, performed in a difference sequence, omitted, or may encompass additional operations not specifically illustrated or described.

In the process illustrated in FIG. 6, and in accordance with one or more aspects of the present disclosure, lender computing system 170 may collect energy asset data (651). For example, with reference to FIG. 1A, one or more of entities 140 may seek to establish a borrower-lender relationship with lender 160. One or more of entities 140, such as entity 140A, provides to lender 160 information (e.g., energy asset data 191) about its property interests, energy reserves, and cash flow. To do so, a system controlled by entity 140A, such as entity computing system 141A, outputs a signal over network 131 and network 132. Lender computing system 170 detects a signal and determines that the signal corresponds to energy asset data 191A from entity computing system 141A. Lender computing system 170 stores energy asset data 191A for later use and/or analysis.

Lender computing system 170 may receive a set of parameters (652). For example, referring again to FIG. 1A, administrator device 161 detects input (e.g., from administrator 162) and outputs a signal over network 132. Lender computing system 170 detects a signal over network 132 and determines that the signal includes information about parameters (e.g., parameter data 192), assumptions, price decks, or other information that can be used to calculate a borrowing base for entity 140A.

Lender computing system 170 may generate cash flow data (653). For example, again referring to FIG. 1A, lender computing system 170 uses energy asset data 191A and parameter data 192 to generate cash flow data 195. In some examples, lender computing system 170 may process energy asset data 191A to transform energy asset data 191A into a standard, uniform, or otherwise appropriate form usable for generating cash flow data 195. In some examples, performing such a transformation may involve significant skilled human intervention and attention. Also, in some examples, lender computing system 170 may use commercially-available software to process energy asset data 191A and/or the transformed energy asset data 191A when generating cash flow data 195.

Lender computing system 170 may calculate borrowing base data (654). For example, still referring to FIG. 1A, lender computing system 170 may apply a number of complex algorithms to compute production output schedules, factor in any hedging instruments or strategies employed by entity 140A, and formulate a range of present values. Lender computing system 170 may generate a number of borrowing base values. Such values may range from an exceptionally safe borrowing base to a more aggressive (and higher) borrowing base.

Lender computing system 170 may receive updated parameters (655). For example, continuing with the example being described in the context of FIG. 1A, administrator device 161 detects input and outputs a signal over 132. Lender computing system 170 determines that the signal includes information about an updated set of parameters (parameter data 192′) that is to be used to calculate a set of updated borrowing base values.

Lender computing system 170 may generate updated cash flow data (656). For example, lender computing system 170 adjusts the previously-generated cash flow data 195A to estimate how cash flow data 195A would change if the previously-generated cash flow data 195A were fully recalculated using the updated parameter data 192′. In some examples, lender computing system 170 may use an interpolation process, described in FIG. 1B, to generate the adjusted cash flow data 195A′.

Lender computing system 170 may calculate updated borrowing base data (657). For example, lender computing system 170 calculates updated borrowing base data 198′ using adjusted cash flow data 195′ and any applicable hedging data. By adjusting cash flow data 195′, rather than regenerating cash flow data 195 entirely from an updated set of energy asset data 191, lender computing system 170 may more quickly and efficiently generate borrowing base data 198′ with little or no loss in accuracy resulting from the adjustments.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, only a limited number of devices (e.g., entity computing systems 141, banking system 151, administrator device 161, lender computing system 270, as well as potential others) are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, and other discs, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

1. A method of presenting a user interface comprising:
collecting, by a computing system, energy asset data maintained by a borrower;
receiving, by the computing system, a signal that includes information about a first set of parameters for evaluating the energy asset data maintained by the borrower;
generating, by the computing system and based on the energy asset data and the first set of parameters, a first set of cash flow data for the borrower;
calculating, by the computing system and based on the first set of cash flow data, a first set of borrowing base data for the borrower, wherein the first set of borrowing base data is calculated pursuant to a first borrowing base analysis, and wherein the first borrowing base analysis is one of a plurality of borrowing base analyses performed by the computing system;
outputting, by the computing system and after calculating the first set of borrowing base data, information sufficient to present a user interface at a lender computing device, wherein the user interface prompts a user of the lender computing device for information that can be used to calculate a second set of borrowing base data;
detecting, by the computing system and based on interactions with the user interface, a signal that corresponds to a request to perform a second borrowing base analysis to calculate the second set of borrowing base data, wherein the interactions with the user interface:
specify that the second borrowing base analysis is to be based on the first borrowing base analysis,
specify that the cash flow data for the second borrowing base analysis is calculated based on the first set of cash flow data, and
specify an updated price deck for calculating the second set of borrowing base data, wherein the updated price deck is chosen from a plurality of available price decks;
determining, by the computing system, that the signal includes information about a second set of parameters, and that the signal identifies the updated price deck;
storing in a data structure, by the computing system, the first set of cash flow data, the information about the second set of parameters, and the identity of the updated price deck;
collecting, by the computing system, updated energy asset data maintained by the borrower;
generating, by the computing system and based on the information stored in the data structure, a second set of cash flow data, wherein the second set of cash flow data is calculated using the updated price deck and the first set of cash flow data to determine approximate values of the updated energy asset data without considering the updated energy asset data maintained by the borrower, and wherein generating the second set of cash flow data includes performing a linear regression analysis based on the first set of cash flow data to estimate a plurality of cash flow items underlying the second set of cash flow data;
calculating, by the computing system and based on the second set of cash flow data and the approximate values of the updated energy asset data, the second set of borrowing base data, wherein the second set of borrowing base data is an estimate of the borrowing base data that would result from a calculation based on the updated energy asset data maintained by the borrower; and
outputting, by the computing system, the second set of borrowing base data.

2. The method of claim 1, wherein the first set of cash flow data for the borrower includes a plurality of cash flows, and wherein generating the second set of cash flow data includes:
performing an interpolation analysis using each of the plurality of cash flows; and
identifying an adjusted value for each of a plurality of cash flow items underlying the first set of cash flow data based on the interpolation analysis.

3. The method of claim 1, wherein the first set of cash flow data for the borrower includes a plurality of cash flows, each based on one of a plurality of different price decks, and wherein generating the second set of cash flow data includes:
calculating a linear regression line using prices from each of the plurality of price decks; and
identifying, based on the linear regression line, an adjusted value for each of a plurality of cash flow items underlying the first set of cash flow data.

4. The method of claim 1, wherein the first set of parameters includes information about a plurality of price decks.

5. The method of claim 1, wherein generating the second set of cash flow data does not require processing of any additional energy asset data associated with the borrower.

6. The method of claim 1, the method further comprising:
calculating, by the computing system and based on the first set of cash flow data for the borrower, hedge adjustments data.

7. The method of claim 6, wherein calculating the first set of borrowing base data includes:
calculating borrowing base data further based on the hedge adjustments data.

8. The method of claim 1, wherein the energy asset data includes:
information about reserves of oil, gas, and natural gas liquids held by the borrower.

9. The method of claim 1, wherein outputting the information sufficient to present the user interface includes:
generating, by the computing system, a user interface enabling generation of a modified price deck; and
wherein determining that the signal includes information about the second set of parameters includes determining further information about interactions with the user interface.

10. The method of claim 1,
wherein collecting energy asset data includes collecting energy asset data for each of a plurality of borrowers;
wherein generating a first set of cash flow data includes generating cash flow data for each of the plurality of borrowers;
wherein calculating the first set of borrowing base data includes generating borrowing base data for each of the plurality of borrowers;
wherein generating the second set of cash flow data includes generating adjusted cash flow data for each of the plurality of borrowers by performing an interpolation analysis using multiple cash flows associated with each respective borrower; and
wherein calculating the second set of borrowing base data includes calculating updated borrowing base data for each of the plurality of borrowers.

11. A system comprising a storage system and processing circuitry having access to the storage system, wherein the processing circuitry is configured to:
collect energy asset data maintained by a borrower;
receive a signal that includes information about a first set of parameters for evaluating the energy asset data maintained by the borrower;
generate, based on the energy asset data and the first set of parameters, a first set of cash flow data for the borrower;
calculate, based on the first set of cash flow data, a first set of borrowing base data for the borrower, wherein the first set of borrowing base data is calculated pursuant to a first borrowing base analysis, and wherein the first borrowing base analysis is one of a plurality of borrowing base analyses performed by the processing circuitry;
output, after calculating the first set of borrowing base data, information sufficient to present a user interface at a lender computing device, wherein the user interface prompts a user of the lender computing device for information that can be used to calculate a second set of borrowing base data;
detect, based on interactions with the user interface, a signal that corresponds to a request to perform a second borrowing base analysis to calculate the second set of borrowing base data, wherein the interactions with the user interface:
specify that the second borrowing base analysis is to be based on the first borrowing base analysis,
specify that the cash flow data for the second set of borrowing base data pursuant to the second borrowing base analysis is the first set of cash flow data, and
specify an updated price deck for calculating the second set of borrowing base data, wherein the updated price deck is chosen from a plurality of available price decks;
determine that the signal includes information about a second set of parameters, and that the signal identifies the updated price deck;
store, in a data structure in the storage system, the first set of cash flow data, the information about the second set of parameters, and the identity of the updated price deck;
collect updated energy asset data maintained by the borrower;
generate, based on the information stored in the data structure, a second set of cash flow data, wherein the second set of cash flow data is calculated using the updated price deck and the first set of cash flow data to determine approximate values of the updated energy asset data without considering the updated energy asset data maintained by the borrower, and wherein to generate the second set of cash flow data, the processing circuitry is configured to perform a linear regression analysis based on the first set of cash flow data to estimate a plurality of cash flow items underlying the second set of cash flow data;
calculate, based on the second set of cash flow data and the approximate values of the updated energy asset data, the second set of borrowing base data, wherein the second set of borrowing base data is an estimate of the borrowing base data that would result from a calculation based on the updated energy asset data maintained by the borrower; and
output the second set of borrowing base data.

12. The system of claim 11, wherein the first set of cash flow data for the borrower includes a plurality of cash flows, and wherein to generate the second set of cash flow data, the processing circuitry is further configured to:
perform an interpolation analysis using each of the plurality of cash flows; and
identify an adjusted value for each of a plurality of cash flow items underlying the first set of cash flow data based on the interpolation analysis.

13. The system of claim 11, wherein the first set of cash flow data for the borrower includes a plurality of cash flows, each based on one of a plurality of different price decks, and wherein to generate the second set of cash flow data, the processing circuitry is further configured to:
calculate a linear regression line using prices from each of the plurality of price decks; and
identify, based on the linear regression line, an adjusted value for each of a plurality of cash flow items underlying the first set of cash flow data.

14. The system of claim 11, wherein the first set of parameters includes information about a plurality of price decks.

15. The system of claim 11, wherein to generate the second set of cash flow data, the processing circuitry does not need to process any additional energy asset data associated with the borrower.

16. The system of claim 11, wherein the processing circuitry is further configured to:
calculate, based on the first set of cash flow data for the borrower, hedge adjustments data.

17. The system of claim 16, wherein to calculate the first set of borrowing base data, the processing circuitry is further configured to:
calculate borrowing base data further based on the hedge adjustments data.

18. The system of claim 11, wherein the energy asset data includes:
information about reserves of oil, gas, and natural gas liquids held by the borrower.

19. The system of claim 11, wherein to output the user interface, the processing circuitry is further configured to:
generate a user interface enabling generation of a modified price deck; and
wherein to determine that the signal includes information about the second set of parameters, the processing circuitry is further configured to determine additional information about interactions with the user interface.

20. A non-transitory computer-readable storage medium comprising instructions that, when executed, configure processing circuitry of a computing system to:
collect energy asset data maintained by a borrower;
receive a signal that includes information about a first set of parameters for evaluating the energy asset data maintained by the borrower;
generate, based on the energy asset data and the first set of parameters, a first set of cash flow data for the borrower;
calculate, based on the first set of cash flow data, a first set of borrowing base data for the borrower, wherein the first set of borrowing base data is calculated pursuant to a first borrowing base analysis, and wherein the first borrowing base analysis is one of a plurality of borrowing base analyses performed by the computing system;
output, after calculating the first set of borrowing base data, information sufficient to present a user interface at a lender computing device, wherein the user interface prompts a user of the lender computing device for information that can be used to calculate a second set of borrowing base data;
detect, based on interactions with the user interface, a signal that corresponds to a request to perform a second borrowing base analysis to calculate the second set of borrowing base data, wherein the interactions with the user interface:
specify that the second borrowing base analysis is to be based on the first borrowing base analysis,
specify that the cash flow data for the second set of borrowing base data pursuant to the second borrowing base analysis is the first set of cash flow data, and
specify an updated price deck for calculating the second set of borrowing base data, wherein the updated price deck is chosen from a plurality of available price decks;
determine that the signal includes information about a second set of parameters, and that the signal identifies the updated price deck;
store, in a data structure, the first set of cash flow data, the information about the second set of parameters, and the identity of the updated price deck;
collect updated energy asset data maintained by the borrower;
generate, based on the information stored in the data structure, a second set of cash flow, wherein the second set of cash flow data is calculated using the updated price deck and the first set of cash flow data to determine approximate values of the updated energy asset data without considering the updated energy asset data maintained by the borrower, and wherein to generate the second set of cash flow data, the instructions configure the processing circuitry to perform a linear regression analysis based on the first set of cash flow data to estimate a plurality of cash flow items underlying the second set of cash flow data;
calculate, based on the second set of cash flow data and the approximate values of the updated energy asset data, the second set of borrowing base data, wherein the second set of borrowing base data is an estimate of the borrowing base data that would result from a calculation based on the updated energy asset data maintained by the borrower; and
output the second set of borrowing base data.
